(19) United States
(12) Patent Application Publication
(10) Pub. No.: US 2025/0386111 A1
(43) Pub. Date: Dec. 18, 2025

(54) Methods And Systems For Compressing Image Data

(71) Applicants: Northeastern University, Boston, MA (US); Washington University, St. Louis, MO (US)

(72) Inventors: Xuan Zhang, Lexington, MA (US); Tianrui Ma, St. Louis, MO (US); Adith Jagadish Boloor, St. Louis, MO (US)

(73) Assignee: Washington Univesity, St. Louis, MO (US)

(21) Appl. No.: 19/237,767

(22) Filed: Jun. 13, 2025

Related U.S. Application Data
(60) Provisional application No. 63/660,414, filed on Jun. 14, 2024.
(60) Provisional application No. 63/663,981, filed on Jun. 25, 2024.

(51) Int. Cl. H04N 25/42; H04N 25/77; H04N 25/78

(52) U.S. Cl. CPC H04N 25/42; H04N 25/77; H04N 25/78

(57) ABSTRACT

Embodiments compress image data. According to an embodiment, analog image data comprising an array of pixel exposure values representing an image is received and the analog image data is convolved with at least one programmable kernel to produce an array of scalar values. The array of scalar values are quantized to generate a quantized feature map. The quantized feature map is a compressed representation of the image relative to the analog image data received.

### RELATED APPLICATIONS

This application claims the benefit of U.S. Provisional Application No. 63/660,414, filed on Jun. 14, 2024 and U.S. Provisional Application No. 63/663,981 filed on Jun. 25, 2024. The entire teachings of the above applications are incorporated herein by reference.

### GOVERNMENT SUPPORT

This invention was made with government support under Grant No. 1942900 awarded by the National Science Foundation. The government has certain rights in the invention.

### BACKGROUND

Image compression has been studied extensively, and there exists a body of research on efficient compression and encoding methods that range from classic discrete cosine transform (DCT)/wavelet-based methods (e.g., JPEG), to emerging end-to-end learned image compression [19]-[21].

### SUMMARY

Existing compression schemes, by and large, are performed in the digital domain. These existing compression schemes demand a significant amount of sensor resources and energy to convert the raw pixels to their digital bit representations during initial image acquisition before compression is applied. Moreover, the existing schemes also rely upon dedicated power-hungry digital compression engines in their image processing pipelines. Therefore, the reduced image size from digital compression does not benefit the image sensor itself (which captures the image) and cannot be readily translated to meaningful resource and energy savings. Alternatively, the concepts of compressive sensing [6] and compressive acquisition [22] have been explored to reduce the image capture and digitization cost at the sensor front-end. However, existing schemes of compressive sensing and compressive acquisition are task-agnostic, resulting in a modest compression ratio with limited task accuracy. These schemes also require computation intensive iterative optimization at the decoding stage in order to reconstruct the image [23] and, thus, are unsuitable for latency-sensitive machine vision applications.

Embodiments solve these problems and provide improved methods and system for compressing image data.

Embodiments disclosed herein provide for a new in-sensor processing paradigm which may be referred to herein as “Learning-based Compressive Acquisition,” i.e., “LeCA,” that targets machine vision applications on the edge. By jointly learning the sensor acquisition function with the downstream computer vision (CV) methods, Embodiments effectively compress the original image into informative condensed feature maps. Co-designed with methods described herein, embodiments may also include a sensor the implements analog-domain in-sensor processing to translate compression into meaningful hardware savings. Evaluated on ImageNet, embodiments show both high compression ratio (6×) and minimal accuracy loss (0.98%). Transistor-level simulation shows a sensor embodiment is 6.3× and 2.2× more energy efficient than conventional sensors and compressive sensing sensors with negligible area overhead.

An example embodiment is directed toward a method for compressing image data. The method includes receiving analog image data comprising an array of pixel exposure values representing an image. The method convolves the analog image data received with at least one programmable kernel to produce an array of scalar values. Further, the method quantizes the array of scalar values to generate a quantized feature map, wherein the quantized feature map is a compressed representation of the image relative to the analog image data received.

In an embodiment, the receiving, convolving, and quantizing are implemented by an encoder packaged within an image sensor. An embodiment further includes, by a pixel array packaged within the image sensor: (i) capturing the image and (ii) transmitting, to the encoder, the analog image data comprising the array of pixel exposure values representing the image.

In an embodiment, convolving the analog image data received with the at least one programmable kernel includes condensing a subset of values from the array of pixel exposure values received into a single scalar value of the array of scalar values.

An embodiment includes identifying at least one feature, of the image, in the quantized feature map and deconvolving the at least one feature identified to produce a partially deconvolved feature map with dimensions equal to dimensions of the image. Such an embodiment transmits the partially deconvolved feature map produced to a computational model, e.g., a computer vision (CV) model or any other computer-based model known to those of skill in the art.

Another embodiment includes cooperatively training: (i) the at least one programmable kernel and (ii) a computer vision (CV) model. According to an embodiment, the cooperatively training includes freezing a weight associated with the CV model and training a pipeline composed of the at least one programmable kernel and the CV model with the weight frozen. In an example, training the pipeline includes adjusting a weight of the at least one programmable kernel and maintaining the weight frozen associated with the CV model.

In embodiments, the CV model may be any model known to those of skill in the art. Amongst other examples, in an embodiment, the CV model is a deep neural network (DNN).

Another embodiment includes transmitting the quantized feature map to a CV model.

Yet another embodiment is directed toward a system for compressing image data. The system includes a pixel array configured to capture an image and an encoder. The encoder is configured to (i) receive, from the pixel array, analog image data comprising an array of pixel exposure values representing the image, (ii) convolve the analog image data received with at least one programmable kernel to produce an array of scalar values, and (iii) quantize the array of scalar values to generate a quantized feature map. The quantized feature map is a compressed representation of the image relative to the analog image data received.

An embodiment of the system also includes an image sensor that includes the encoder and the pixel array.

In an embodiment, the pixel array is further configured to transmit, to the encoder, the analog image data comprising the array of pixel exposure values representing the image.

According to an embodiment of the system, to convolve the analog image data received with the at least one programmable kernel, the encoder is configured to condense a subset of values from the array of pixel exposure values received into a single scalar value of the array of scalar values.

An embodiment of the system further includes a decoder. In an embodiment, the decoder may be configured to (i) identify at least one feature, of the image, in the quantized feature map, (ii) deconvolve the at least one feature identified to produce a partially deconvolved feature map with dimensions equal to dimensions of the image, and (iii) transmit the partially deconvolved feature map produced to a computer-based model, e.g., a CV model.

In an embodiment, the system includes a CV model or any other computer-based model known to those of skill in the art. According to an embodiment, the at least one programmable kernel and the CV model are cooperatively trained. In an embodiment, the cooperatively training includes freezing a weight associated with the CV model and training a pipeline composed of the at least one programmable kernel and the CV model with the weight frozen. Training the pipeline may include adjusting a weight of the at least one programmable kernel and maintaining the weight frozen associated with the CV model.

In yet another embodiment, the encoder further comprises an analog processing element (PE) and an analog-to-digital converter (ADC). According to an embodiment, the analog PE includes: (i) a p-channel metal oxide semiconductor (PMOS) source follower (PSF) buffer, (ii) a switched-capacitor multiplier (SCM), (iii) a flipped voltage follower (FVF), or (iv) any combination of (i)-(iii). According to yet another embodiment, the analog PE is configured to (i) obtain a weight from the at least one programmable kernel, (ii) using the weight obtained, perform the convolving of the analog image data received with the at least one programmable kernel utilizing a multiply-accumulate (MAC) operation, and (iii) transmit a result of the MAC operation to the ADC, wherein the ADC is configured to perform the quantizing to generate the quantized feature map.

Another embodiment is directed toward an apparatus for compressing image data. In an embodiment, the apparatus may include means for receiving analog image data comprising an array of pixel exposure values representing an image, means for convolving the analog image data received with at least one programmable kernel to produce an array of scalar values, and means for quantizing the array of scalar values to generate a quantized feature map, wherein the quantized feature map is a compressed representation of the image relative to the analog image data received.

It is noted that embodiments of the method, system, and apparatus may be configured to implement any embodiments or combination of embodiments described herein.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1A is a simplified block diagram illustrating a conventional complementary-metal-oxide (CMOS) image sensor (CIS) floorplan.

FIG. 1B is a block diagram illustrating circuit level cell structure of a 4-T pixel cell that may be implemented in the CMOS sensor of FIG. 1A.

FIG. 2 is a block diagram illustrating a legacy human centric vision processing pipeline and a machine-centric vision processing pipeline according to an embodiment.

FIG. 3 is a flow diagram illustrating a method for compressing image data, according to an embodiment.

FIG. 4A is a block diagram illustrating an image processing pipeline in an embodiment.

FIG. 4B is block diagram of a sensor system embodiment.

FIG. 5A is a plot of accuracy, of embodiments, for a markers parameter sweep versus compression ratio.

FIG. 5B is a plot of accuracy for a pipeline of an embodiment versus kernel size.

FIG. 6A is a diagram illustrating kernel flattening processes that may be implemented by embodiments.

FIG. 6B is a diagram illustrating column-parallel processing implemented by one or more processing elements (PEs) in an embodiment.

FIG. 6C is a diagram illustrating a pixel block processing method that may be implemented by embodiments.

FIG. 7A illustrating execution of the pixel block processing method of FIG. 6C by the sensor.

FIG. 7B is a timing visualization of an operation sequence of the processing illustrated in FIG. 7A for multiple components of the sensor, according to an embodiment.

FIG. 8A is a circuit diagram of a sensor system illustrating processing of raw pixel values, as voltage signals, according to an embodiment.

FIG. 8B is a timing diagram for the sensor system of FIG. 8B, according to an embodiment.

FIG. 9A is a plot illustrating output of a full system transistor-level simulation of an embodiment performed in a standard CMOS 65 nm process.

FIG. 9B is a plot illustrating ideal output of a full system transistor-level simulation of an embodiment performed in a standard CMOS 65 nm process.

FIG. 10 is a block diagram illustrating a method for evaluating embodiments.

FIGS. 11A and 11B are plots comparing downstream classification accuracy of image compression performed by embodiments and existing methods, on TinyImageNet and ImageNet datasets, respectively, with varying compression ratios.

FIG. 11C is a plot of accuracy loss versus compression ratio for an embodiment and existing compression techniques.

FIGS. 12A and 12B are plots illustrating accuracy of embodiments, trained according to vary modalities, when processing proxy and ImageNet datasets, respectively.

FIG. 13 is a chart illustrating encoded and decoded features of an image, according to an embodiment.

FIGS. 14A-14C are plots illustrating the energy consumption, normalized energy, and accuracy of conventional, compressive, and embodiment sensors.

### DETAILED DESCRIPTION

A description of example embodiments follows.

The modern imaging world craves rich contextual information, much of which is driven by diverse vision applications thanks to the expansion of various consumer camera devices and image sensors in the past decades. Apart from serving the growing demand of social networks, image sensors also play vital roles in many industrial and scientific applications, such as security monitoring [1], environmental sensing [2], and medical imaging [3]. In these first-generation vision applications, humans are often the end-consumers of the images and, therefore, faithful capture and reconstruction of the original light scene becomes an important quality measure. However, recent accelerated advancements in deep learning (DL)-based computer vision (CV) have unleashed a second wave of machine vision. In this second wave, voluminous vision data is increasingly generated by intelligent devices, e.g., edge devices, and consumed, not by humans, but rather by downstream CV methods/models configured to perform sophisticated tasks such as classification, recognition, and machine perception [4]-[6]. Images that are destined for downstream vision methods/models do not need high-fidelity reconstruction, e.g., the reconstruction that is desired for human use. Embodiments leverage this fact and provide compression techniques that do not consider impact on the ability to perform high-fidelity reconstruction. Instead, embodiments provide compression techniques that preserve the “task-specific” information, e.g., the information relied upon by CV methods/models and, thereby, reduce energy consumption and save hardware costs.

### Existing Methods

Modern image sensors are generally configured to perform the fundamental utility of converting light to electrical signals for later storage, processing, communication and consumption. In conventional image sensors, all pixels are indiscriminately converted to a pre-defined digital format with a fixed bit depth (e.g., 8-bit). Considerable energy and resources of the overall image sensor system are dedicated to (i) the readout peripheral, (ii) the analog-to-digital conversion (ADC) circuits, (iii) the on-chip storage, and (iv) the off-chip transmission of the raw image frame after the image frame is captured and digitized. These traditional image sensor components occupy a significant portion of the silicon area and contribute significantly to power and latency of the image sensor. Moreover, as resolution of the image data increases, so does the silicon area, power, and latency. For example, a survey on state-of-the-art image sensors [7]-[18] has shown that both the ADC and output buffer circuits consume 69% of the sensor's power, 34% of the pixel row's readout time, and more than 60% of pixel array area.

CMOS image sensors (CISs) are one of the most popular vision frontends. A CIS typically consists of a pixel plane, column-parallel readout circuits, ADC circuits, output buffers, and a serial communication interface configured to transmit the image data off-chip.

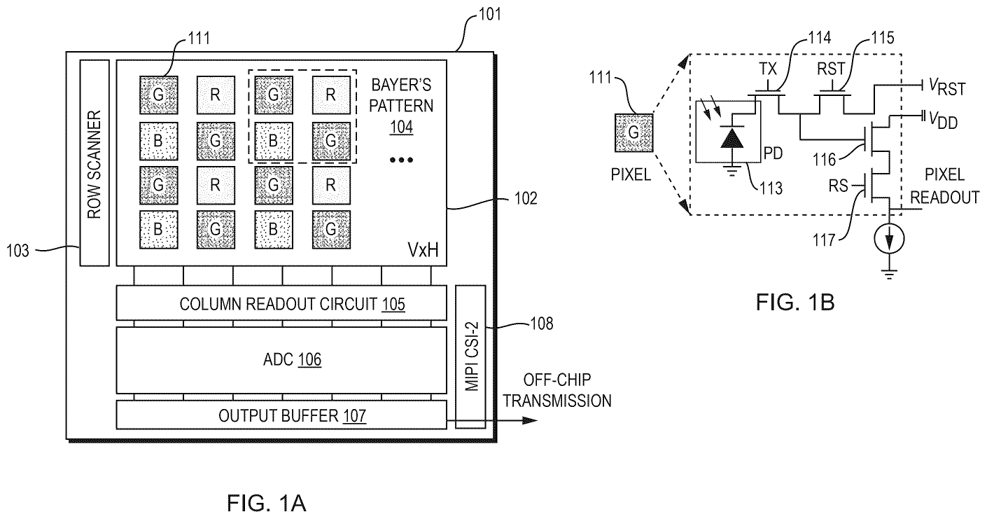

FIG. 1A is a simplified block diagram illustrating a conventional CIS 101 floorplan. In the CIS 101 floorplan, a two-dimensional (2D) pixel plane 102 extends vertically (V) and horizontally (H) with V×H pixels, e.g., 111. FIG. 1B is a block diagram illustrating circuit level cell structure of a 4-T pixel cell 111 that may be implemented in the CIS sensor of FIG. 1A. As can be seen in FIG. 1B, a typical active pixel sensor (APS) 111 design employs a 4-T pixel cell structure. This 4-T pixel cell structure includes a pinned photodiode 113, a transfer switch 114, a reset transistor 115, a source follower transistor 116 and a row select transistor 117.

Returning to FIG. 1A, in color image sensors, the color filter array is placed on top of the pixel plane 102 to multiplex visible light with different wavelengths. The filter array is typically placed in a Bayer pattern [27] 104. In the Bayer pattern 104, a 2×2 pixel block (two green, one red, and one blue) is grouped together, where the number of green filters is twice that of the red and blue filters in order to emulate human vision sensitivity. This Bayer pattern 104 of the raw image is later processed digitally by demosaicing through color interpolation to recover the full-color image for display. Under regular frame rate operations, CIS commonly adopts a rolling shutter by exposing the pixel plane 102 row by row via the row scanner 103. This allows the pixels in the same column to share one set of circuits that includes a column readout circuit 105 and ADC 106. The number of ADCs 106 is thus determined by the image width (Horizontally) in a rolling-shutter CIS. After the ADC 106, the digitized image is stored in the output buffer 107 and streamed out through a serial interface 108 (e.g., MIPI CSI-2). The ADC 106 and output buffer 107 account for a significant proportion of the sensor's power, latency, and area; and the energy consumed by the serial communication link 108 may be significant.

Sensor side image compression is an effective method to alleviate the large storage and transmission overheads caused by high-resolution image data. Standard compression techniques such as lossy predictive coding [28], variable length-coding [29], and JPEG encoding [30] exploit abundant spatial redundancy in natural images for compression. Apart from these classic methods, learned image compression has recently been explored, such as probability methods [31], generative adversarial networks [20], and autoencoders [32], [33]. These learned image compression methods learn only the most important features within the images to compress and recover the images with minimal perceptual loss. General techniques that compress neural network feature maps such as sparsity [34], [35], and quantization [36], [37] can also be applied to reduce the input image size. However, these aforementioned schemes are exclusively performed in the digital domain after acquiring the digital images, hence they provide no resource or power-saving opportunity to the sensor chip, e.g., 101. Moreover, digital compression requires dedicated processing engines whose power consumption often dwarfs that of the image sensor itself. For example, efficient JPEG engines consume on the order of nJ/pixel to compress the image [38], [39], several times the power of the conventional image sensor.

Alternatively, image compression may be achieved during the image acquisition process. Constrained by the limited computation that can be implemented inside the sensor chip, existing heuristic algorithms tend to include simple operations such as encoding the neighboring pixel's intensities [40], encoding a block of pixels based on its mean, gradient, and bitmap [41], perturbing pixels to achieve low-resolution quantization [42], encoding pixel gradient to logarithmic representation [43], and skipping pixels with small accumulated gradients [44].

Another existing approach to image compression is compressive sensing (CS), which aims to reduce the sensor cost associated with image capture. CS exploits the sparsity of natural images and allows the raw images to be progressively reconstructed with a small number of linear measurements. When CS is applied to image sensors, these measurements are often obtained by multiplying the image with a random binary/ternary matrix and using the weighted sum of one or more blocks of pixel values to encode and represent the acquired images [45]. A downside of CS is its use of an iterative optimization method for image reconstruction that converges slowly, making it unsuitable for real-time machine vision tasks.

What existing compressive acquisition and CS solutions share in common is that they are all task-agnostic methods optimized and evaluated not by specific vision task performance, but rather by general image quality factors such as PSNR and SSIM [46]. TABLE I below summarizes the characteristics of these different approaches to image compression. As can be seen in TABLE I, embodiments of the present disclosure not only translate effective compression to meaningful hardware resource and energy savings, but embodiments also deliver superior end-to-end task accuracy and performance.

TABLE I
Comparison of Image Compression Methods

| Compression | Encoding | Objective | Quality | Hardware |
|---|---|---|---|---|
| Method | Domain | Function | Metric | Overhead |
| Standard [28]- | Digital | Task Agnostic | PSNR | High |
| [30] | | | | |
| Learned [20], | Digital | Task Agnostic | PSNR | Medium |
| [31]-[33] | | | | |
| Heuristic | Mixed | Task Agnostic | PSNR | Medium |
| Acquisition [22], | | | | |
| [42], [44] | | | | |
| Compressive | Analog | Task Specific | PSNR | Low |
| Sensing [45] | | | | |
| Embodiments of | Analog | Task Specific | Accuracy | Low |
| the Present | | | | |
| Disclosure (e.g., | | | | |
| LeCA) | | | | |

In a conventional image processing pipeline, the digitized image captured by the sensor is fed to a digital image signal processor (ISP) chip for post processing to improve the image quality [47]. However, reviews on image compression methods suggest that if compression, or lower-dimensional feature extraction, of the image can be performed directly inside the sensor, preferably in the analog domain, then less data needs to be explicitly digitized and transmitted off-chip for later processing. Such in-senor architectures have recently been explored with several possible implementations: pixel-level, column-level, and chip-level processing, according to the location of the PEs [48]. Due to the stringent pixel size, pixel-level PEs can only employ a few transistors and perform only limited computations to avoid severe degradation of the fill factor [49]-[52]. Chip-level PEs are placed next to the pixel array and processes the pixel readouts sequentially, resulting in low computational parallelism [53]. A variant of chip-level processing is to stack the sensor chip onto the processing chip with through-silicon-vias [54], [55] or hybrid bonds [56], which incurs higher fabrication and packaging cost in exchange for smaller pixel size and higher frame rate [57], [58]. In column-level processing, the PE resides with the column readout circuit that is shared by the pixels in one or multiple adjacent columns [59], [60]. This provides a middle ground that balances between the area/complexity of the in-sensor circuitry and the processing parallelism.

A number of in-sensor processing circuits have been proposed to perform various pixel-weight operations such as max/min, logarithm, multiplication, and summation with current [4], [61]-[63], voltage [43], or charge-domain [64] implementations. These analog-domain circuits allow in-sensor pre-processing before signal digitization. In particular, vector multiplication is one of the atomic arithmetic operations that are commonly used in many pre-processing tasks. The sensor of embodiments adopts column-level processing with charge-domain multipliers to perform the learned compressive encoding on the raw pixel values.

Embodiments disclosed herein provide a “Learning-based Compressive Acquisition” (“LeCA”) method configured to extract condensed, task-relevant, features from an image instead of defaulting to the fixed quantization scheme universally adopted by existing compressive sensing/acquisition solutions [24]-[26]. Embodiments exploit an opportunity in the modern machine vision pipeline where image data is consumed by deep neural network (DNN) based downstream CV models, obviating the need to reconstruct the original image to appease human-centric visual quality metrics.

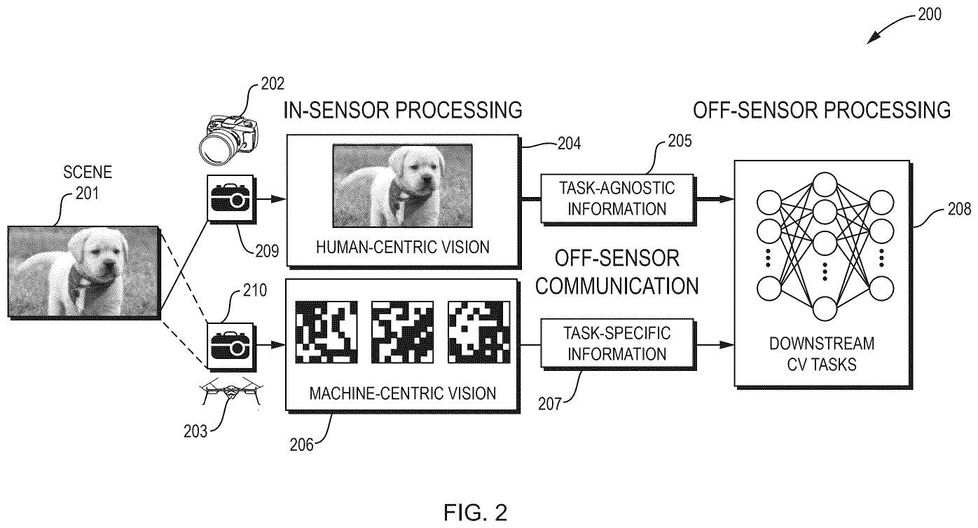

FIG. 2 is a block diagram illustrating a legacy human centric vision processing pipeline and a machine-centric vision processing pipeline according to an embodiment. In the legacy processing pipeline, an image 209 of the scene 201 is captured by, for example, an image sensor 202. The legacy pipeline continues by performing in sensor human-centric vision processing 204 for the image 209. The legacy in sensor processing 204 is intended to appease traditional human centric visual quality metrics, e.g., does the image resemble the original scene 201 in a conventional way to the human eye. The in-sensor human-centric processing 204 produces task agnostic information 205 that is then used in off-sensor processing 208, e.g., downstream CV tasks. The in-sensor processing 204 to produce the task-agnostic information 205 is optimized and evaluated not by specific vision task performance (i.e., performance of the off-sensor processing 208), but rather by general human-centric image quality factors such as peak signal-to-noise ratio (PSNR) and structural similarity index measure (SSIM) [46].

Embodiments may start similarly to the legacy pipeline and capture an image 210 of the scene 201 using an image sensor 203. However, according to an embodiment, the image 210 of the scene 201 is captured with a pixel array packaged within the image sensor 203. The pipeline, according to an embodiment, continues by performing in-sensor machine-centric vision processing 206. The in-sensor machine-centric processing 206 produces task-specific information 207 that is then used in off-sensor processing 208, e.g., downstream CV tasks. Since the pipeline according to an embodiment produces task-specific information 207, such an embodiment is not required to reconstruct the scene 201 to be visually pleasant to a human, but rather can focus on only reconstructing task specific information for off-sensor processing 208, e.g., downstream CV tasks. This allows embodiments to provide significant energy savings.

An embodiment includes a hardware/processing co-design approach that is made feasible by the combination of three techniques. First, such an embodiment stacks an autoencoder before the downstream CV model. The stacking enables cooperative training of the task-specific features in an end-to-end manner. According to an embodiment, the autoencoder comprises a single encoding layer with lightweight decoder layers, thereby facilitating an in-sensor implementation of the compressive encoding layer. Second, an embodiment implements a hardware-aware noise-tolerant training process that incorporates both the analytical behavioral models and noise models of the analog-domain multiplier and buffer circuits to properly account for their circuit-level nonidealities, thereby leading to more precise hardware instantiation and superior accuracy of the trained models implementing embodiments. Third, the sensor system, according to an embodiment, employs a column-parallel processing element (PE) array using switched-capacitor multipliers (SCMs) to enable compressive feature extraction and variable low-resolution quantization directly at the sensor front end. In addition to improving the energy efficiency of the image sensor itself, embodiments reduce the image size right from the source, which reduces required memory storage and saves computing power for later-stage processing.

With column-parallel PE arrays, programmable encoder weights, and programmable channel dimensions, embodiments flexibly scale with image resolution and adapt to varying compression ratios, making embodiments a practical solution for energy-efficient machine vision applications.

Embodiments disclose novel image sensor hardware, and a novel image compression framework configured to exploit the cooperative learning of a sensor autoencoder with the downstream methods, e.g., a CV method, in order to compress the original pixel-wise image data into task-specific, low-dimension, features with adaptable bit depth and minimal task accuracy loss. The disclosed hardware-aware, noise-tolerant, training process is tailored for the framework disclosed herein where the circuit-level behaviors and non-idealities of framework's analog-domain hardware are fully accounted for. Further, embodiments provide for efficient implementation in standard complimentary-metal-oxide-semiconductor (CMOS) 65 nm technology employing column-parallel analog-domain PE arrays with variable-resolution ADCs to perform the single-layer encoder. The compression-accuracy trade-off of embodiments against alternative compression methods have been validated using comprehensive benchmark datasets (ResNet-50 on ImageNet).

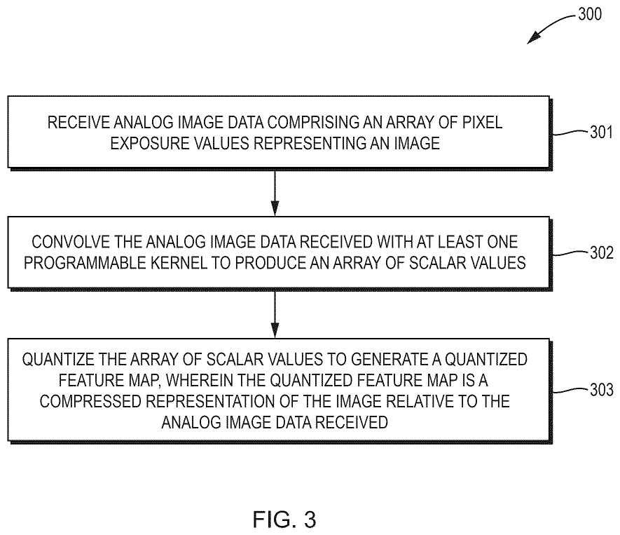

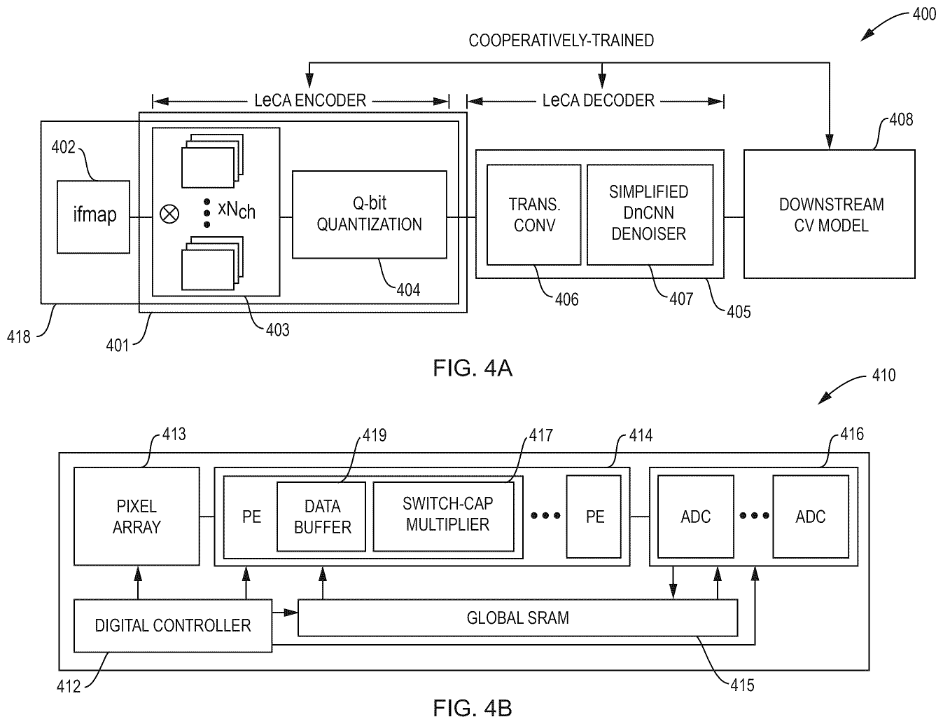

FIG. 3 is a flow diagram illustrating a method 300 for compressing image data, according to an embodiment. The method 300 begins at step 301 by receiving analog image data (e.g., a voltage signal) comprising an array of pixel exposure values representing an image, for example, the image 210 of FIG. 2. Next, at step 302, the analog image data received at step 301 is convolved with at least one programmable kernel to produce an array of scalar values. According to an embodiment, a kernel, i.e., a convolutional (programmable) kernel, may be a square matrix whose elements are convolutional weights. According to an embodiment, the convolving may be performed by analog processing elements, such as the processing element 403 of FIG. 4A, discussed herein below. In turn, at step 303 the array of scalar values is quantized to generate a quantized feature map. In an embodiment, the quantizing may be performed by an ADC, such as the ADC 404 of FIG. 4A, discussed herein below. The quantized feature map is a compressed representation of the image relative to the analog image data received.

According to an embodiment of the method 300, the receiving at step 310, convolving at step 302, and quantizing at step 303 are performed by an encoder packaged within an image sensor. In an embodiment, a pixel array is also packaged within the image sensor. For example, in an embodiment, the encoder 401 of FIG. 4A, and the pixel array 413 of FIG. 4B, discussed herein below is packaged within the image sensor 418. The pixel array may be configured to capture the image and transmit the analog image data (which is received at step 301) including the array of pixel exposure values to the encoder.

In an embodiment of the method 300, convolving the analog image data with at least one programmable kernel at step 302 may include condensing a subset of values from the array of pixel exposure values into a single scalar value of the array of scalar values.

An embodiment of the method 300 may also include identifying at least one feature of the image in the quantized feature map, deconvolving the identified at least one feature to produce a partially deconvolved feature map having dimensions equal to dimensions of the image, and transmitting the partially deconvolved feature map to a CV model. According to an embodiment, the deconvolving may be performed by a decoder, for example, the decoder 405 of FIG. 4A, discussed hereinbelow.

Embodiments of the method 300 also may include cooperatively training the at least one programmable kernel and a computer-based model, e.g., a CV model. Cooperatively training may include freezing a weight (or weights) associated with the CV model and training a pipeline composed of the at least one programmable kernel and the CV model with the frozen weight. Training the pipeline may include adjusting a weight (or weights) of the at least one programmable kernel and maintaining the frozen weight associated with the CV model. According to an embodiment of the method 300, the CV model may be a DNN. Further, an embodiment of the method 300 further includes transmitting the quantized feature map to a downstream computer-based model, e.g., a CV model.

Further, embodiments may also be directed to a system for compressing image data. According to an embodiment, the system may include a pixel array and an encoder. In an embodiment, the pixel array is configured to capture an image. Moreover, the encoder may be configured to (i) receive, from the pixel array, analog image data comprising an array of pixel exposure values representing the image, (ii) convolve the analog image data received with at least one programmable kernel to produce an array of scalar values, and (iii) quantize the array of scalar values to generate a quantized feature map, wherein the quantized feature map is a compressed representation of the image relative to the analog image data received.

An embodiment of the system may additionally include an image sensor, wherein the image sensor includes the encoder and the pixel array. The pixel array may be further configured to transmit, to the encoder, the analog image data comprising the array of pixel exposure values representing the image.

For example, in an embodiment of the method 300, the image, e.g., 210 of FIG. 2, may contain analog image data, e.g., the input feature map (ifmap) 402, in the pixel array 413, that is received by the encoder 401 of FIGS. 4A and 4B, respectively, discussed herein below. In an embodiment, the convolving (step 302) may be performed by analog processing elements, such as the processing element 403 of FIG. 4A, and the quantizing (step 303) may be performed by an ADC, such as the ADC 404 of FIG. 4A, discussed herein below.

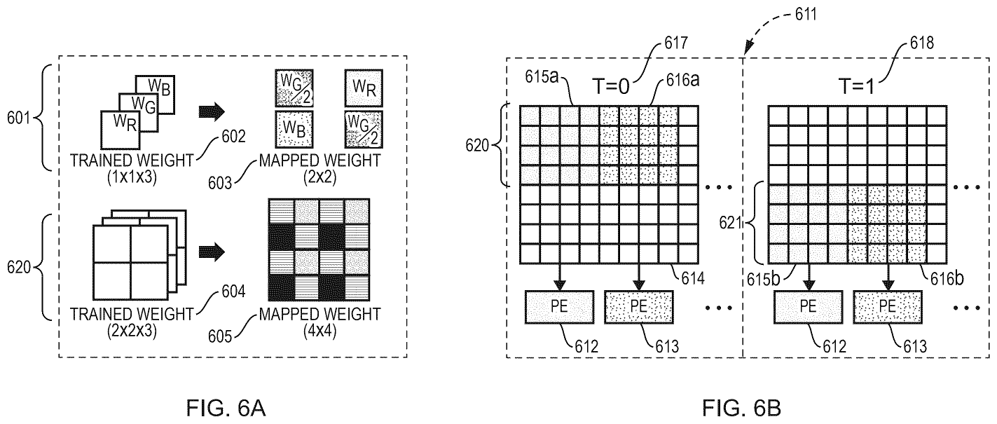

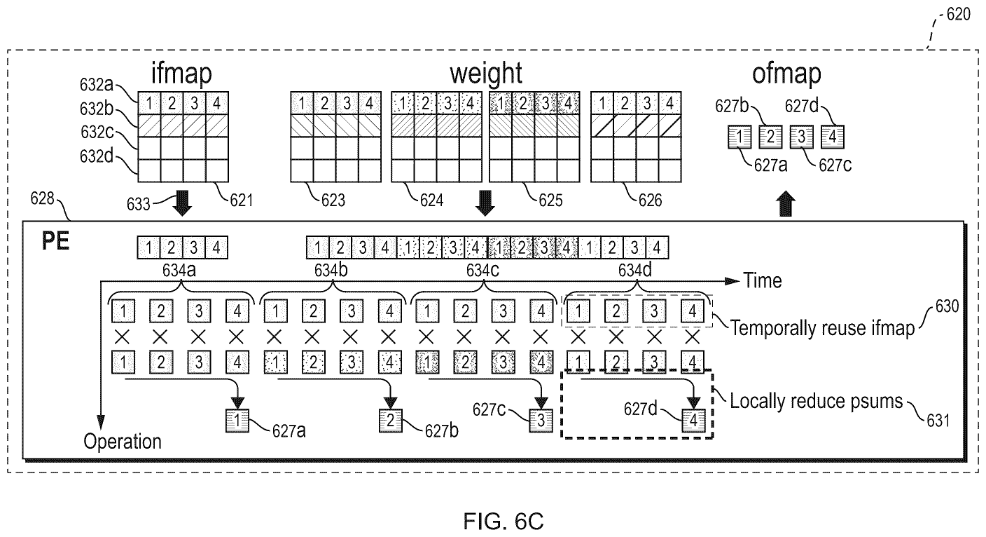

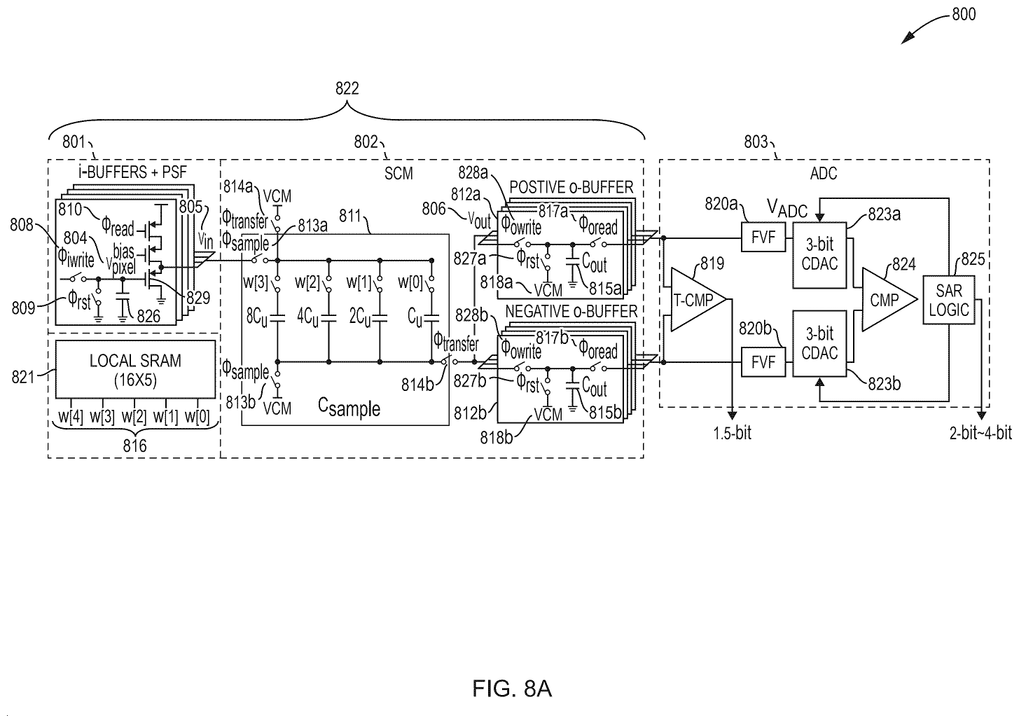

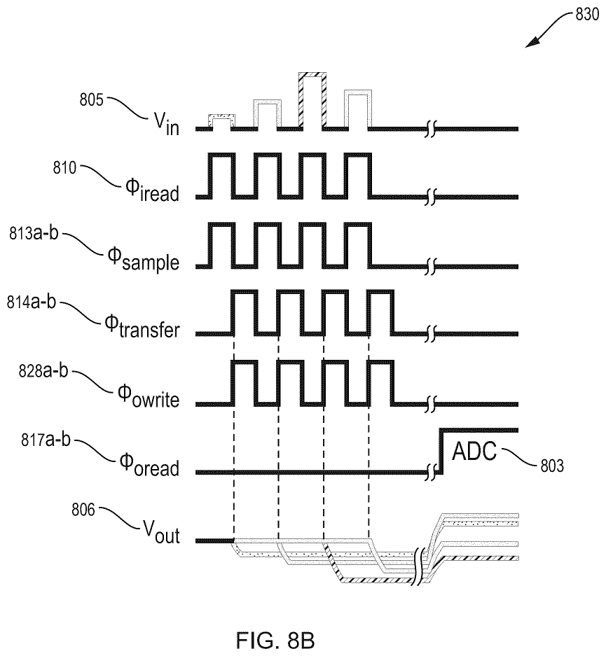

In an embodiment of the system, to convolve the analog image data received with the at least one programmable kernel, the encoder may be configured to condense a subset of values from the array of pixel exposure values received into a single scalar value of the array of scalar values. The encoder may include an analog PE and an ADC, for example, the PE 822 and the ADC 803 of FIG. 8A, discussed herein below. The analog PE may include: (i) a p-channel metal oxide semiconductor (PMOS) source follower (PSF) buffer (See FIG. 8A 829), (ii) a SCM (See FIG. 8A 802), a flipped voltage follower (FVF) (See FIG. 8A 820a-b), or (iv) any combination of (i)-(iii). Further, according to an embodiment, the analog PE may be configured to obtain a weight from the at least one programmable kernel. Using the weight obtained, the PE may perform the convolving of the analog image data received with the at least one programmable kernel utilizing a multiply-accumulate (MAC) operation (See FIG. 6C, 634a-d). Further still, the PE may be configured to transmit a result of the MAC operation to the ADC, wherein the ADC is configured to perform the quantizing to generate the quantized feature map.

The system, according to an embodiment, may also include a decoder, for example, the decoder 405 of FIG. 4A. The decoder may be configured to (i) identify at least one feature, of the image, in the quantized feature map, (ii) deconvolve the at least one feature identified to produce a partially deconvolved feature map with dimensions equal to dimensions of the image, and (iii) transmit the partially deconvolved feature map produced to a CV model.

In an embodiment of the system, the at least one programmable kernel and the CV model may be cooperatively trained. The cooperative training may include freezing a weight associated with the CV model and training a pipeline composed of the at least one programmable kernel and the CV model with the frozen weight. According to an embodiment, training the pipeline may include adjusting a weight of the at least one programmable kernel and maintaining the weight frozen associated with the CV model.

Further still, embodiments disclosed herein may include an apparatus for compressing image data. The apparatus may include means for receiving analog image data comprising an array of pixel exposure values representing an image, e.g., image sensor 203 of FIG. 2 and encoder 401 of FIG. 4A discussed herein below, means for convolving the analog image data received with at least one programmable kernel to produce an array of scalar values, e.g., the analog PE 403 of FIG. 4A discussed herein below, and means for quantizing the array of scalar values to generate a quantized feature map, e.g., ADC 404 of FIG. 4A discussed herein below, wherein the quantized feature map is a compressed representation of the image relative to the analog image data received.

### Example Framework

Two central tenets were followed in the development of an embodiment (e.g., LeCA). First, such an embodiment is designed for resource-constrained image sensors. In such sensors, it may be important to reduce energy consumption and to limit the area overhead of the sensor chip itself, prompting the need to perform image encoding and compression in the analog domain before digitization. Second, such an embodiment targets the modern machine vision processing pipeline, where images are consumed by downstream methods, e.g., CV models, rather than by human visual inspection. This allows for an end-to-end measure of success instead of the traditional image quality metrics.

An embodiment provides a hardware and methodology co-design framework comprising two synergistically-optimized components (i) an encoder/decoder model that is jointly trained with a backbone DNN for the downstream processing tasks (e.g., a CV model) and (ii) an in-sensor processing architecture that efficiently implements the encoder layer directly inside the sensor chip. On the methodology side, an embodiment adopts an encoder decoder structure [65] and stacks it before the downstream processing model (e.g., DNN). According to an example implementation, the encoder performs a single-layer convolution between the raw red-green-blue (RGB) image and the encoder's learned kernels. The convolution output is then quantized to a low-resolution feature map. According to an embodiment, bit depths may vary between 1.5-bit (ternary) and 4-bit. The decoder reconstructs task specific features from the encoded feature map to the same size of original image. Both the encoder and decoder take the form of convolution layers (in an embodiment, the encoder and decoder are effectively convolutional neural networks and the encoder may have a single layer, and the decoder may have multiple layers) and are cooperatively-trained with the downstream model (e.g., DNN) so that design parameters are aware of the downstream task accuracy.

FIGS. 4A and 4B are block diagrams illustrating an image processing pipeline 400 and sensor system diagram 410, respectively, according to an embodiment.

Referring to FIG. 4A, the pipeline 400 includes an encoder 401, decoder 405 and downstream CV model 408. In operation, input image data 402 at the image sensor 418 comprising an array of pixel exposure values representing an image, i.e., an input feature map (ifmap), is received, and sent to an analog PE 403 within the encoder 401. According to an embodiment, the PE 403 may include a PSF buffer, a SCM, and/or a FVF. The PE 403 convolves the analog image data 402 with at least one programmable kernel by utilizing a MAC operation which results in an array of scalar values. The result of this MAC operation (i.e., the array of scalar values) is then transmitted to the ADC 404, which is configured to perform a Q-Bit quantization to quantize the array of scalar values to generate a quantized feature map. The quantized feature map is then passed to the decoder 405. The decoder 405 includes a transpose convolutional layer 406 as well as a simplified denoising convolutional neural network (DnCNN) denoiser 407. The transposed convolutional layer 406 and simplified DnCNN denoiser 407 process the quantized feature map to identify features specific to the downstream CV model 408. For example, the transposed convolutional layer 406 up-samples the compressed (down-sampled and quantized) image back to the original image size. In turn, the identified task specific features are transferred to the downstream CV model 408, e.g., a frozen downstream CV model. The CV model 408 can then perform its configured processing, e.g., classification, identification, etc. In the pipeline 400, both the downstream CV model 408 and the encoder 401 are jointly/cooperatively trained. The joint/cooperative training ensures the encoder 401 produces information that is compatible with what the downstream CV model 408 is expecting to receive.

In extreme low-power edge machine vision applications (e.g., always-on surveillance [14], wellness monitoring [66]), it is paramount to reduce the sensor energy beyond the conventional CIS implementation. The novel sensor architecture 410 provides such a reduction. The novel sensor architecture 410 embeds the computation of an encoder into the sensor and implements the computation with analog-domain PE arrays to achieve significant image data compression with high energy efficiency.

As shown in FIG. 4B, the sensor architecture 410, according to an embodiment, comprises five parts, a pixel array 413, PE array 414, ADC array 416, digital controller 412, and global static random-access memory (SRAM) 415. In the architecture 410, each PE of the array 414 of PEs includes a data buffer 419 and SCM 417. According to an embodiment, the data buffer 419 (i.e., i-buffers/PSF 801 of FIG. 8A) is used to temporarily store analog image data. Moreover, in an embodiment, the SCM 417 is used to perform convolution. According to an embodiment, the pixel array 413 contains column-parallel analog pixel readout circuits with row-wise rolling shutter exposure (not shown). The PE array 414 receives analog pixel values from the pixel array 413 as input feature maps (e.g., ifmap 402), fetches digital encoder kernels from the global SRAM 415 as weights, and generates analog output feature maps (ofmap) through charge-domain MAC operations. The ADC array 416 performs digital quantization on the analog ofmap and resolution of the quantization is variable from 1.5-bit to 4-bit. The quantized ofmap is stored in the global SRAM 415 to be transmitted off-chip. The digital controller 412 cooperates with a row scanner (not shown), to control data scheduling and operation timing from the start of the exposure to the final readout of the quantized ofmap.

The encoder-decoder structure is implemented as it enables plug-and-play of embodiments on top of a learning-based machine vision pipeline without modifying the backbone DNN structures or retraining the entire pipeline. Although embodiments could further reduce the energy/latency benefits of the downstream CV models due to image compression [67], the scope of embodiments is focused on the sensor chip energy and performance.

Table II below indicates the network structure of an encoder, e.g., 401, and decoder, e.g., 405, according to an embodiment.

TABLE II
Network Structure of Encoder and Decoder

| | | | |
|---|---|---|---|
| Layer | Ifmap Dimensions | Weight Dimensions | Ofmap Dimensions |

LeCA Encoder

| | | | |
|---|---|---|---|
| CONV | W × H × C | K × K × C × N_{ch} | $\frac{W}{K} \times \frac{H}{K} \times {N}_{ch}$ |

LeCA Decoder

| | | | |
|---|---|---|---|
| CONV Transpose | $\frac{W}{K} \times \frac{H}{K} \times {N}_{ch}$ | K × K × N_{ch} × C | W × H ×C |
| CONV +ReLU | W × H × C | K × K × N_{ch} × C | W × H × C |
| (M Layers) | W × H ×F | K_{d} × K_{d} × C × F | W × H × F |
| CONV + BatchNorm | | | |
| + ReL | | | |
| CONV | W × H × F | K_{d} × K_{d} × F × C | W × H × C |

In an embodiment, the encoder, e.g., 401, is deliberately simplified. The encoder has only one convolution layer with non-overlapping kernels and a limited number of output channels (N_{ch}), as shown in TABLE II above. In this way, each kernel condenses a K×K×C pixel block in the ifmap (e.g., 402 FIG. 4A) into a single element in the ofmap, thereby achieving K²× and C× compression in the ifmap's spatial domain and input-channel domain, respectively. Here, K is both the kernel size and stride length, K_{d} is the kernel size of the decoder's convolutional layers, and C is the number of input channels (C=3 for RGB colorspace). After the encoder convolution layer (e.g., 403), according to an embodiment, the ofmap is hard-truncated and uniformly quantized (e.g., using the ADC 404) to its low-resolution (Q_{bit}) representation, thereby achieving

$$\frac{{Q}_{full}}{{Q}_{bit}}$$

×compression in the ofmap's bit depth domain where Q_{full}=8 represents the full resolution of typical images. Therefore, the compression ratio (CR) achieved by the encoder in such an embodiment is shown in Equation (1) below:

$$C R = \frac{K \times K \times C \times {Q}_{full}}{{N}_{ch} \times {Q}_{bit}} \qquad ( 1 )$$

Intentionally choosing a small N_{ch} ensures that the compression gained through ifmap down-sampling and quantization is not offset by a large number of ofmaps. The simplicity of the encoder (e.g., 401) and the low-resolution quantization also enables energy-efficient hardware implementation.

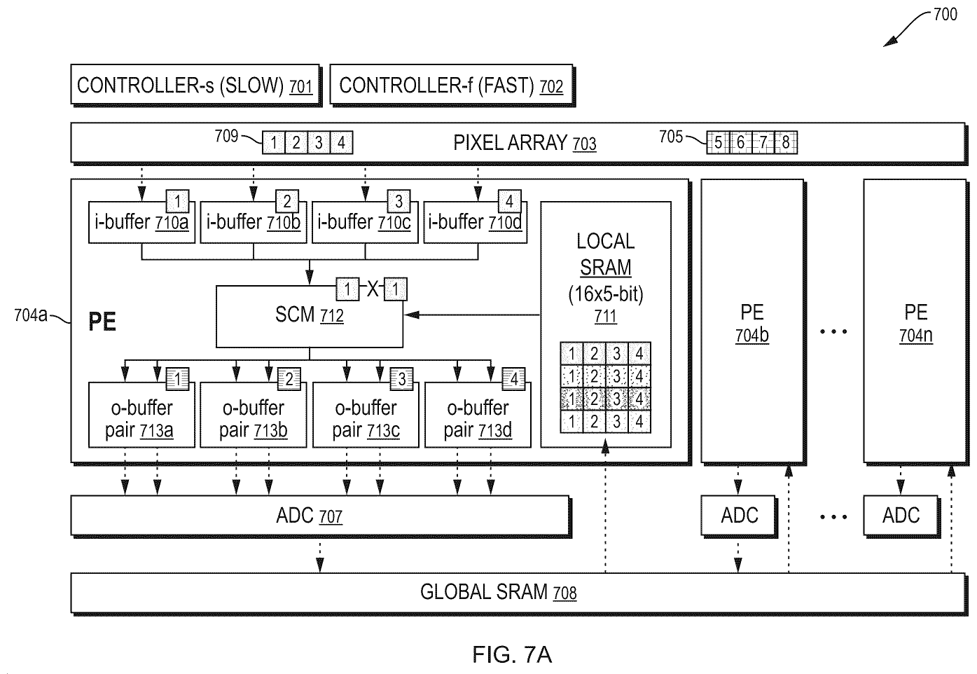

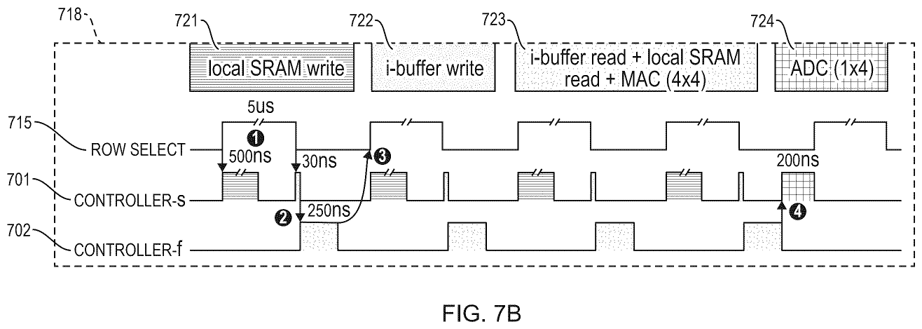

According to an embodiment, after the image data is transmitted off-chip (i.e., off the encoder, e.g., 401), the quantized ofmap is first up-sampled to the size of the original ifmap (e.g., 402 FIG. 4A) through a single layer transposed convolution block (e.g., 406 FIG. 4A), as shown in TABLE II above. Thereafter, up-sampled ofmap is denoised through a simple DnCNN [68](e.g., 407 FIG. 7) that includes M stacked convolutional blocks. Complicated decoder designs used for image quality enhancement (e.g., PSNR, SSIM) are not necessary, as the decoder, according to an embodiment, aims to retrieve the salient information from the quantized ofmap that contributes to the downstream task (e.g., 408) accuracy. Evaluation has suggested that sufficient accuracy is achieved when the number of DnCNN layers (e.g., in DnCNN 407) is M=15 and the number of convolutional filters (e.g., in DnCNN 407) is F=64, which takes only a fraction of the parameter sizes used in the state-of-the-art DNN backbone models (e.g., ResNet18/50).

According to Equation (1) above, the level of compression in an embodiment is determined by three key parameters associated with the encoder: (1) the encoder's convolution kernel size K, (2) the number of encoded features N_{c}h, and (3) the bit depth of the encoded features Q_{bit}. These parameters participate in the tradeoff between compression ratio, hardware complexity, and downstream task accuracy. Here, this tradeoff was investigated to identify an optimal setting of the encoder parameters using a proxy machine vision pipeline. As used herein, “proxy” refers to the TinylmageNet [69] dataset on a ResNet [70] downstream model being used as a preliminary, timesaving, “proxy” experiment testbed, prior to performing experiments on ImageNet.

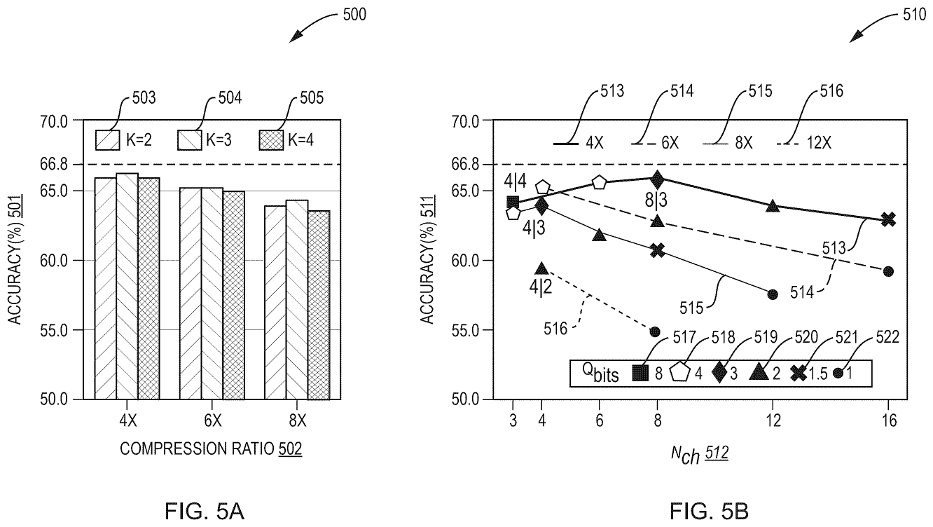

FIGS. 5A and 5B show plots 500 and 510, respectively, illustrating the accuracy for the proxy pipeline (i.e., the overall pipeline involving the TinylmageNet “proxy” dataset) under various kernel sizes (plot 500 of FIG. 5A) and the accuracy for N_{ch} and Q_{bit} (markers) parameter sweep across compression ratios {4, 6, 8, 12} for K=2 (plot 510 FIG. 5B). The best accuracies are marked in N_{ch}|Q_{bit} notation for each compression ratio.

Plot 500 of FIG. 5A is a bar graph illustrating the accuracy percentage 501 for each compression ratio 502, for K=2 503, K=3 504, and K=4 505 kernel sizes. In FIG. 5A, the effect of K (503-505) is explored under three different compression ratios 502 on the proxy pipeline, according to an embodiment. Plot 500 shows that while high compression leads to some accuracy degradation, choosing K∈{2 (503), 3 (504), 4 (505)} gives similar inference accuracy. From a hard-ware perspective, a smaller K (503-505) means that fewer consecutive MAC operations are needed and a smaller portion of the ofmap is to be buffered, resulting in lower hardware complexity. K=1, which does not perform spatial downsampling, is not included because it requires aggressive Q_{bit} and N_{ch} to achieve adequate compression, which leads to poor accuracy. Therefore, K=2 503 is fixed out of hardware efficiency consideration.

FIG. 5B shows a plot 510 illustrating the accuracy percentage 511 for the number of channels (N_{ch}) 512, with respect to an encoder's compression ratio (CR) according to an embodiment, e.g., 4× compression 513, 6× compression 514, 8× compression 515, and 12× compression 516. Further, plot 510 also shows the respective Q_{bit}s 517-522 for each compression ratio 513-516. The remaining design space of the encoder is completely characterized by N_{ch} (512) and Qbit (517-522) and there exists a clear and critical tradeoff between the encoder's CR and the downstream task accuracy. The inference accuracy was investigated by sweeping over N_{ch} (512) and Q_{bit} (517-522) combinations under different CRs. As can be observed in FIG. 5B, increasing the CR 513-516 with lower N_{ch} 512 and Q_{bit} 517-522 values leads to degradation in end-to-end task accuracy. For a fixed CR of 4× 513, as N_{ch} 512 increases and Q_{bit} 517-522 decreases, the best performance is observed at the middle, suggesting that too few N_{ch} 512 or too aggressive Q_{bit} 517-522 leads to poor accuracy. The optimal N_{ch} 512 and Q_{bit} 517-522 combination that gives the highest inference accuracy varies for different CRs 513-516. Empirically, it can be observed in plot 510 of FIG. 5B that for CRs of 4× 513, 6× 514, 8× 515, N_{ch}|Q_{bit} of 813, 414, and 413, respectively are the optimal configurations. According to an embodiment, the hardware is designed to support programmable N_{ch}|Q_{bit} configurations.

### Example Training Methodology

Given the analog-domain implementation of the encoding layer and the stacked nature of the machine vision pipeline, according to an embodiment, a customized training methodology is employed to tackle a number of unique challenges that differentiate embodiments from the typical DNN-based CV model training process.

In an embodiment, all parameters in the encoder-decoder are learned simultaneously, i.e., cooperatively trained, with the downstream CV model (e.g., ResNet) to maximize end-to-end task accuracy. The entire pipeline may be trained with a cross-entropy loss that is typical for image classification tasks. This is in contrast to prior works that train to minimize the reconstruction loss between the raw and decoded images [71]. Particularly, the training, according to an embodiment, is performed by freezing the backbone DNN with its pre-trained weights. This means that during backpropagation, the gradients are calculated for each layer of the DNN, but its weights are not updated. Those gradients propagate back to the encoder (e.g., 401 FIG. 4A) and decoder (e.g., 405 FIG. 4A) to allow weight updates. This cooperative training allows embodiments to extract task-specific information in its encoding layer that emphasizes end-to-end task accuracy over the conventional visual reconstruction quality. In an embodiment, freezing the backbone weights is deliberately chosen as this enables embodiments to easily swap the backbone out for other models without retraining the entire end-to-end network.

Embodiments may also be trained to be hardware-aware and noise-tolerant. Although embodiments can obtain learned weights from digital training, transferring the weights to the hardware model is not trivial due to hardware non-idealities. In order to minimize the accuracy degradation after the software-to-hardware mapping, an embodiment considers comprehensive hardware non-idealities in the training forward path, including hardware constraints (e.g., limited signal range, limited precision, and constrained polarity), hardware offsets, and hardware noise and variations. Specifically, according to an embodiment, the convolution of the encoder layer is implemented by an analog PE (e.g., 414 FIG. 4B) that includes three circuit stages—a PSF buffer (e.g., 419 FIG. 4B), a SCM (e.g., 417 FIG. 4B), and a FVF buffer (e.g., 820a-b FIG. 8A).

Unlike ideal buffers and multipliers, PSF and FVF buffers cause linear scaling and offsets, and SCM performs precision-limited multiplication with gain error. To deal with hardware constraints, in an embodiment, the numerical values of the data are set in the encoder to be consistent with the real signal range in the PE circuit, and the encoder's weight is quantized to the hardware precision. According to an embodiment, the hardware offsets are modeled in two different ways. First, for circuits with fixed transfer functions (PSF and FVF), the hardware offsets are approximated with analytical regression functions and are inserted in the training forward path. Specifically, in an embodiment, both transfer functions in PSF and FVF are modeled as linear functions. Second, for circuits with programmable transfer functions (SCM and ADC), the programmable circuit parameters are incorporated in the training loop by inserting the exact circuit behavior models in the training forward path. Specifically, SCM takes both ifmap and weight for MAC operations and, instead of finding a mapping between the weight and the real circuit parameter in the SCM that represents the weight after training, an embodiment directly trains that circuit parameter during backpropagation. Similarly, an embodiment directly trains the ADC's (e.g., 404 FIG. 4A) quantization boundary.

To deal with hardware noise and variations, an embodiment models the noise at each circuit stage, from pixel acquisition to the end of ofmap digitization, and inserts the modeled noise into the training forward path stage by stage. Direct training on the full noise model leads to poor convergence. Instead, an embodiment first pre-trains a noise-free pipeline and, then, finetunes the pipeline by incorporating the various noise models, e.g., at each circuit stage. A key aspect in the training method, according to an embodiment, is dealing with hardware offsets and noises in an iterative manner due to the temporally-multiplexed weights unique to the operation of embodiments, unlike existing hardware-aware training that is solely applied to spatially-multiplexed weights [72], [73], [92].

An example embodiment has three training modalities: 1) soft training, i.e., training a convolutional layer without any hardware non-idealities; 2) hard training, i.e., replacing the software computation by the circuit analytical models with hardware constraints and offsets; and 3) noisy training, i.e., replacing the software computation by the actual circuit behaviors with hardware constraints, offset, and noise/variations.

An embodiment provides for differentiable backpropagation and incremental training. In the training pipeline, an embodiment models the ADC as an uniform quantizer. However, this prevents gradients from flowing during backpropagation due to the non-differentiable quantization function. To solve this, an embodiment employs a straight through estimator (STE) [74] technique. Specifically, during training, such an embodiment ensures proper gradient flow by using Equation (2):

$$f ( x ) = q ( x ) + x - stop - gradient ( x ) \qquad ( 2 )$$

where q(·) denotes the quantization function and stop-gradient(·) means that the variable is included in the forward path, but excluded from the gradient calculation. Equation (2) ensures that in the forward path only the quantized values are propagated while during backpropagation, the actual value of x is used for gradient calculation.

In addition to addressing a non-differentiable quantizer, it can be observed that directly training with aggressive quantization (e.g., Q_{bit}≤4) generally leads to sub-optimal convergence. To alleviate this issue, an embodiment trained a model with more lenient quantization (e.g., Q_{bit}=8), and, then, weights from this trained model with lenient quantization were used to initialize the model that is trained with lower Q_{bit}. This strategy helps the model converge faster. It is noted that since the decoder comes after the ADC, there is no need for further compression; hence, full precision is used for the decoder's weights and activations.

### Example Sensor Architecture and Circuits

In an embodiment, the sensor (e.g., 410 FIG. 4b) may be designed with a pixel array (e.g., 413) size of 448×448, with a Bayer pattern filter (e.g., 104) where the green pixel is duplicated. This means that the sensor in such an embodiment captures a full frame of 224×224×3 color image in which 3 stands for the RGB color channels. Note that in this embodiment the encoder is trained on RGB images.

FIG. 6A is a diagram illustrating kernel flattening processes 601 and 620, according to an embodiment. In the example process 601, trained weight includes a (1×1×3) kernel 602. The associated weights of the green color channel are halved and duplicated, thereby flattening the (1×1×3) kernel 602 to a mapped weight with a kernel size of (2×2) 603. In the process 620, each kernel (2×2×3) 604 of the encoder is mapped to the kernel on raw images by halving and duplicating the trained weights of the green color channel. This process 620 effectively flattens the (2×2×3) convolutional kernel to a (4×4) kernel 605.

FIG. 6B is a diagram illustrating a column-parallel processing method 611 according to an embodiment. FIG. 6B illustrates the process 611 at time instant (T) T=0 617 (i.e., initial state) and T=1 618 (i.e., subsequent state). In an embodiment, a 448×448 pixel array would utilize 112 identical PEs as each set of 4 columns shares one exclusive PE. In the embodiment illustrated in FIG. 6B, at T=0 617, the convolution is performed for the first four rows 620 of pixels of the pixel array 614 (e.g., the pixels 615a are processed by the PE 612 and the pixels 616a are processed by the PE 613). Similarly, at T=1 618, the convolution is performed for the next four rows of pixels 621 following the first four rows of pixels 620 (e.g., the pixels 615b are processed by the PE 612 and the pixels 616b are processed by the PE 613). To illustrate a simplified example, FIG. 6B shows a 9×9 pixel array 614 where two PEs 612 and 613 perform column-parallel processing at T=0 617 on the non-overlapping 4×4 pixel blocks 615a and 616a, respectively, and at T=1 column-parallel processing is performed on the non-overlapping 4×4 pixel blocks 615b and 616b, respectively according to an embodiment.

To illustrate the processing dataflow, FIG. 6C shows an example processing method 620 in which a PE 628 processes an example 4×4 pixel block 621 (rather than a full resolution image, for brevity and clarity), according to an embodiment. Here, N_{ch} is 4 and, thus, four ofmap elements (627a-d) are generated. Bias in the convolution is ignored here for simplicity. In the sensor, the ifmap 621 and the partial sum (psum)/ofmap 627a-d are in the analog domain while the weights 623-626 are in the digital domain. To reduce analog data movement, the sensor adopts an input-stationary dataflow: the ifmap 621 is temporally reused 630 and the psums 631 are locally reduced. In the beginning, the first row 632a in the ifmap 621 and each weight 623-626 are buffered 633 in the PE 628. During the PE 628 processing, 16 MAC operations 634a-d are sequentially performed by loading the ifmap_{1,2,3,4} 621 cyclically and loading the weight_{1,2,3,4} 623-626 in kernel 1 to kernel 4 consecutively. The psum 627a-d generated from every MAC operation is reduced locally: during the MAC operations with ifmap_{1,2,3,4} 621 and weight_{1,2,3,4} 623 in kernel 1, the four psums are reduced to psum₁ 627a. Similarly, for the MAC operations with ifmap_{1,2,3,4} 621 and weight_{1,2,3,4} 624 in kernel 2, the four psums are reduced to psum₁ 627b; for the MAC operations with ifmap_{1,2,3,4} 621 and weight_{1,2,3,4} 625 in kernel 3, the four psums are reduced to psum₁ 627c; and for the MAC operations with ifmap_{1,2,3,4} 621 and weight_{1,2,3,4} 626 in kernel 4, the four psums are reduced to psum₁ 627d. After sixteen MAC operations, psum_{1,2,3,4} 627a-d are generated and buffered. Then, the second and third rows 632b and 632c in the ifmap and each weight are buffered and processed, and the newly generated psum_{1,2,3,4} are accumulated to the previously buffered psum_{1,2,3,4}. After processing the fourth row 632d of the ifmap 621 and the weight 626, sixty-four MAC operations are performed in total and the ofmap_{1,2,3,4} are generated and popped out of the buffer.

FIG. 7A is a block diagram of a sensor 700 according to an embodiment, illustrating how the example of FIG. 6C unfolds in hardware in a PE 704a. According to an embodiment, all PEs share the same processing dataflow except each PE receives a different ifmap.

Returning to FIG. 7A, the PE 704a receives, from the pixel array 703, ifmap_{1,2,3,4} 709 and the PE 704b receives ifmap_{5,6,7,8} 705 from the pixel array 703. Each PE 704a-n contains four ifmap buffers 710a-d (i-buffers) for ifmap storage, a 16×5-bit local SRAM 711 for weight storage, a SCM 712 to perform consecutive MAC operations, and four ofmap buffers 713a-d (o-buffers) for psum accumulation and ofmap storage. The o-buffers 713a-d transfer an analog ofmap to ADC 707, which transfers a digital ofmap to the global SRAM 708. According to an embodiment, each PE 704a-n can at most process four ofmap elements, corresponding to 4 kernels. When the number of kernels (N_{c}h) is larger than four, e.g., N_{ch}=8, after popping out ofmap_{1,2,3,4}, the ifmap_{1,2,3,4} is buffered to the PE again together with the weight_{1,2,3,4} in kernel 5 to kernel 8, generating ofmap_{5,6,7,8}.

To take advantage of the SCM's fast operation without imposing high network-on-chip (NoC) bandwidth requirements, an embodiment applies a hybrid strategy where the timing of the sensor 700 is coordinated by two controllers in different clock domains—a slow controller-s 701 at, for example, 100 MHz, and a fast controller-f 702 at, for example, 400 MHz. In FIG. 7A the dashed arrows are synchronized by the controller-s 701 while the solid arrows are synchronized by the controller-f 702. The operation sequence among each component of the sensor 700 is described hereinbelow in relation to FIG. 7B.

FIG. 7B is a timing visualization 718 illustrating an operation (local SRAM 711 write 721; buffer 710a-d write 722; buffer 710a-d read/local SRAM 711 read/SCM 712 MAC 723; and ADC 707 724) sequence among components of the sensor 700 of FIG. 7A. In step 1, once the readout for the first row of pixels starts (ROWSEL 715 is on), the row scanner triggers controller-s 716 to enable writing 721 16×5-bit weights from the global SRAM 704 to the local SRAM 711. The local SRAM 711 write 721 consumes 500 ns and the pixel readout typically takes ˜5 μs, thus the latency of the local SRAM 711 write 721 is hidden behind that of the pixel readout. When pixel readout is finished (ROWSEL 715 off), controller-s 701 enables writing 722 of four analog pixel values (ifmap) to i-buffers 710a-d, consuming 30 ns.

In the second step, controller-s 701 triggers controller-f 702 to consecutively read 723 weights from the local SRAM 711 to the SCM 712, and cyclically reads 723 the four ifmap elements from the i-buffers 710a-d to the SCM 712. The generated psums are written to the o-buffers 713a-d. This step takes 250 ns.

In the third step, after 16 psums are accumulated to o-buffers 713a-d, controller-f 702 triggers the row scanner to readout 721 the second row of pixels, while also triggering the controller-s 701 to write the next batch of weights to local SRAM 721.

In the fourth step, after processing four rows of pixels, controller-s 701 is triggered to fetch 724 the four ofmap elements from the o-buffers 713a-d to the ADC 707, and finally to the global SRAM 708, which consumes 200 ns. Depending on N_{ch}, the row scanner can either trigger the readout of the 5^{th} row (if N_{ch}≤4), or trigger the readout of the first row again for repetitive readout (if N_{ch}>4).

According to an embodiment, as the encoder processes the image row by row, frame latency is determined by the encoder processing latency of each row accumulated over the height of the pixel array. The row processing latency is dominated by pixel readout prior to computation, especially when repetitive readout is needed. Based on the timing diagram in FIG. 7B, the frame rate is estimated to reach about 209 fps with 448×448 resolution.

FIG. 8A is a circuit diagram of a sensor system 800 illustrating analog domain processing of raw pixel values, as voltage signals, according to an embodiment. The circuit diagram of PE 800 illustrates how pixels are processed in the analog domain inside the sensor system 800, as they go through i-buffer 801, SCM 802, and ADC 803 to complete an encoding operation, according to an embodiment.

The sensor system 800 includes a PE 822 and an ADC 803. The PE 822 includes i-buffers 801, local SRAM 821, and SCM 802. The SCM 802 is composed of a capacitor block 811, positive output buffers 812a and negative output buffers 812b. The ADC 803 includes ternary comparator (T-CMP) 819, a pair of FVFs 820a-b, a pair of 3-bit capacitive digital-to-analog converters (CDACs) 823a-b, a comparator (CMP) 824, and successive approximation register (SAR) logic 825.

In the embodiment of FIG. 8A, the building blocks of the sensor system 800 include pixel array (not shown), PE array 822, and ADC array 803. Regarding the pixel and analog readout, an embodiment adopts standard 4-T pixel (See FIG. 1A 102, 103, and 105; and FIG. 1B 111). In an embodiment, the pixel array size is set to 448×448 to match ImageNet's image resolution (224×224×3) with ifmap/weight flattening. The energy of pixel exposure and readout is estimated as 12.1 pJ/pixel based on previous work [75].

In the embodiment of FIG. 8A, in the first PE 822 stage the i-buffer 801 is implemented using metal-oxide-metal (MOM) capacitors, e.g., 826. The analog pixel readout is stored as voltage (Vₚᵢₓₑₗ) 804 at the capacitor 826 through ϕ_{iwrite} 808 and reset through ϕᵣₛₜ 809. To drive the SCM 802, the i-buffer 801 is followed by a PSF 829 which reads V_{i-buffer} out as Vᵢₙ 805 through ϕ_{iread} 810. According to an embodiment, the capacitance of the capacitor 826 is 109 fF.

In operation, there are four i-buffers 801 in the sensor system 800, which each share one SCM 802 for MAC operation and the computation precision is ±4-bit. The SCM 802 consists of a 4-bit sampling capacitor (Cₛₐₘₚₗₑ) 811 for magnitude multiplication, and differential o-buffers 812a-b for sign operation. The trained weight w[4:0] is read out from the local SRAM 821, with the magnitude bits w[3:0] setting how much capacitance is connected in the Cₛₐₘₚₗₑ 811, and the sign bit determining if the Cₛₐₘₚₗₑ 811 is connected to the positive o-buffer 812a or the negative o-buffer 812b.

The SCM 802 performs MAC operations in a time-multiplexing manner. After the local SRAM 821 sets Cₛₐₘₚₗₑ 811, Vᵢₙ 805 is sampled to Cₛₐₘₚₗₑ's 811 top plate through ϕₛₐₘₚₗₑ 813a-b. Then with ϕₛₐₘₚₗₑ 813a-b off and ϕ_{transfer} 814a-b on, the sampled charge is transferred to Cₛₐₘₚₗₑ's bottom plate, and redistributed between Cₛₐₘₚₗₑ 811 and Cₒᵤₜ 815a-b in one of the o-buffers 812a-b. In the buffers 812a-b, when ϕ_{transfer} 814a-b is on, the corresponding o-buffer write switch ϕ_{owrite} 828a-b is on, depending on which capacitor 815a-b in the o-buffer 812a-b is being written. When performing quantization, with ϕ_{owrite} 828a-b off, both ϕ_{oread} 817a and 817b are on to transfer the differential analog ofmap to ADC 806 through FVFs 820a-b. In this way, the multiplication of the Vᵢₙ 805 and the weight w[4:0] 816 is finished, and the psum is stored as voltage (Vₒᵤₜ) 806 at Cₒᵤₜ 815a-b. Time-multiplexed on/off of the ϕₛₐₘₚₗₑ (813a-b)-ϕ_{transfer} (814a-b) with different Vᵢₙ 805 and w[4:0] 806 updates the Vₒᵤₜ 806 cycle by cycle, realizing the consecutive MAC operations, as illustrated in the timing diagram 830 in FIG. 8B. Analytically, after the it cycle of ϕₛₐₘₚₗₑ (813a-b)-ϕ_{transfer} (814a-b), the Vₒᵤₜ 806 is as in Equation (3):

$${V}_{out} [ i ] = \frac{{C}_{sample} [ i ] ( 2 {V}_{CM} - {V}_{in} [ i ] ) + {C}_{out} {V}_{out} [ i - 1 ]}{{C}_{out} + {C}_{sample} [ i ]} \qquad ( 3 )$$

where Vₒᵤₜ 806 [i−1] is the voltage on the Cₒᵤₜ 815a-b after the first i−1 cycles; Vᵢₙ[i] is the input voltage 805 to SCM 802 at the i cycle; Cₛₐₘₚₗₑ 811 [i] is the connected capacitance in the SCM 802 at the i^{th} cycle; and VCM 818a-b is a constant voltage that can be applied via ϕᵣₛₜ 827a-b. The total capacitance of the sampling capacitance is C_{sample,tot}=135 fF.

Conventionally, the o-buffer 812a-b has much larger capacitance (Cₒᵤₜ (815a-b) C_{sample,tot} 811) to reduce the incomplete charge transfer which incurs large area overhead [64]. However, with a hardware-aware training technique disclosed herein, according to an embodiment, an extremely-low

$$\frac{{C}_{out}}{{C}_{sample , total}}$$

ratio can be tolerated, allowing an embodiment to utilize Cₒᵤₜ 815a-b at 135 fF (ratio=1) to save notable area.

In an embodiment, four pairs of Vₒᵤₜ 806 (each pair of V_{outcoming} from a respective buffer 801) are sequentially quantized by a differential-input ADC 803. The ADC's 803 resolution is reconfigurable to accommodate different Q_{bit}. When Q_{bit}=1.5-bit (ternary), the differential Vₒᵤₜ 806 is connected to T-CMP 819 [76]. For higher bit depth (Q_{bit}>1.5), the differential Vₒᵤₜ 806 may be sampled to a successive approximation register ADC 823a-b [77] through a pair of FVFs 820a-b [78]. According to an embodiment, the FVFs 820a-b are a buffer between the SCM 802 and the ADC 803, the FVFs 820a-b may be understood as either an isolated buffering stage that is separate from the ADC 803, or a pre-amplification stage of the ADC 803. In an embodiment, the CMP 824 and SAR logic 825 are components of the ADC 803. The CMP 824 compares the differential analog input data, and the SAR logic 825 returns an output bit as well as controls signals to the CDACs 823a-b. The ADC 803 may be configurable to 8-bit resolution to support normal sensing mode. In the normal mode, after each row exposure, a digital controller (not shown) enables the pixels to bypass the PE 822 and be quantized by the ADC 803 through four quantization cycles.

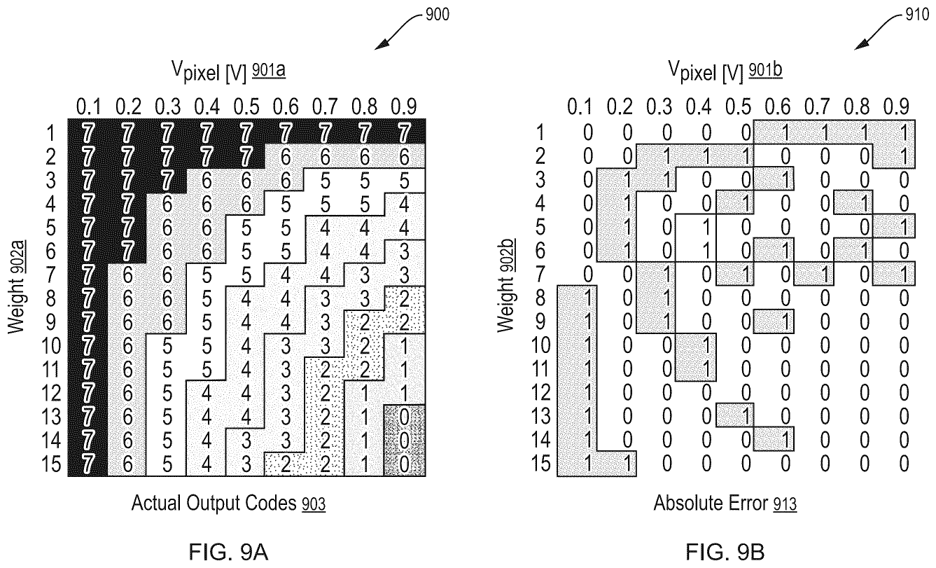

FIG. 9A is a plot 900 illustrating output of a full system transistor-level simulation of an embodiment performed in a standard CMOS 65 nm process. Similarly, FIG. 9B is a plot 910 illustrating ideal output of a full system transistor-level simulation of an embodiment performed in a standard CMOS 65 nm process. Plot 900 shows actual output codes 903 as a function of Vₚᵢₓₑₗ 901a and weights 902a. Plot 910 shows absolute error 913 as a function of Vₚᵢₓₑₗ 901b weights 902b. The plot 900 of FIG. 9A validates the correctness of the system.

To obtain the results in plots 900 and 901, 65 nm was chosen, as the CIS technology scaling has to balance the degraded photon sensitivity in smaller pixel size and therefore typically lags behind the more aggressive scaling of the digital process. Since the sign operations are performed on independent o-buffers, the output code with negative weight is central symmetric to the one with positive weight. Without loss of generality, in the simulation, the ADC's resolution was set to 4-bit and the weights 902a were always positive, so the output code 903 ranged from 0 to 7. The simulation results are shown in plot 900 of FIG. 9A, and the output code 903 correctly changed from 7 to 0 along with increased {Vₚᵢₓₑₗ 901a, w 902a}. Referring to plot 910 of FIG. 9B, comparing to the results from an analytical circuit model where the PSF/FVF/ADC are linear and the SCM exactly follows Equation (3), the absolute error 913 in the actual output codes was within one least significant bit (LSB). The absolute error 913 came from the PSF/FVF/ADC's nonlinearity, the SCM's offset, and the ADC's offset. The ADC's nonlinearity and offset may be easily calibrated digitally, and all other nonidealities were considered in the hardware-aware training using stage-wise, fine-grained look-up-tables.

### Experimental Methodology

To evaluate embodiments, six alternative compression methods were compared, including the conventional full-precision sensor. Embodiments were compared with 1) a conventional sensor (CNV), e.g., a CIS, having pixel-wise uniform quantization with 8-bit precision; 2) spatial down-sampling (SD) having block-wise spatial averaging of the pixel values with 8-bit uniform quantization; 3) low-resolution quantizer (LR) having pixel-wise uniform quantization with low precision; 4) compressive sensing (CS) [45] having block-based compressive sensing using random matrix for measurement and L0 normalization for reconstruction; 5) Microshift (MS) [42] having fixed value-shifting pattern performed to each block of pixels and each pixel is quantized to low resolution; and 6) accumulated gradient thresholding (AGT) [44] where pixel gradients are accumulated over the neighboring pixels and the pixels are skipped until the sum crosses a threshold. The task accuracy of all these methods was evaluated using a frozen ResNet-style network as the downstream DNN.

The methodology according to an embodiment was validated on TinyImageNet [69] and ImageNet [79]. TinyImageNet is a subset of the ImageNet dataset down-sampled to 64×64 with 200 classes. For Tiny-ImageNet, a random rotation of 20 degrees and random horizontal flipping was used during training. PyTorch [80] was used with its provided pre-trained weights for ResNet-like [70] downstream DNN models. Adam [81] was used as the optimizer to train an embodiment for 100 epochs for TinyImageNet and 25 epochs for ImageNet while keeping the downstream weights frozen. The learning rate started at 10-3 and decayed by a factor of 0.1 every 30 epochs for TinyImageNet, and every 10 epochs for ImageNet with a batch size of 256.

Comprehensive noise sources and non-ideality effects in the sensor of an embodiment were modeled and added to the training pipeline to fine-tune the pre-trained encoder and decoder of the embodiment.

Pixel array noise was added to the images to emulate real CIS sensing effects, including shot noise and read noise, which were formulated as Poisson and Gaussian distributions, respectively. The digital image was converted to its voltage intensity, the equivalent noise in the voltage domain was added, and finally was converted back to the digital image.

The analog non-ideality includes three parts, starting from pixel readout to ADC:
(1) PSF's non-linear transfer function and mismatch—200-sample Monte-Carlo simulations were conducted to obtain the PSF's transfer function with mismatch variation incorporated. The PSF's readout effect was thus modeled as a look-up-table (LUT) with input-related Gaussian disturbance: Vᵢₙ[i]=N(LUT_{PSF}(Vₚᵢₓₑₗ[i]), σ_{PSF}[i]).
(2) The SCM's incomplete charge transfer and mismatch—the SCM's output was calculated by the ideal analytical model (See Equation (3), LUT_{SCM}) and superimposed by an input/weight-related error term with Gaussian disturbance, which was obtained from a 200-sample Monte-Carlo simulation. The SCM multiplier's computation effect was thus modeled as: Vₒᵤₜ[i]=LUT_{SCM}(Vᵢₙ[i], weight[i])−N(ϵ_{SCM}[i], σ_{SCM}[i]).
(3) FVF's non-linear transfer function and mismatch—similar to the PSF, the FVF's readout effect was also modeled as a LUT with input-related Gaussian disturbance: V_{ADC}[i]=N (LUT_{FVF}(Vₒᵤₜ[i]), σ_{FVF}[i])

The hardware non-ideality model lumps the effects of time invariant process variations (e.g., spatial mismatch) with time variant fluctuations due to supply, temperature, and aging as random statistical variables. In this way, embodiments comprehensively capture non-ideal behaviors in the training process without the need to retrain for each hardware instantiation.

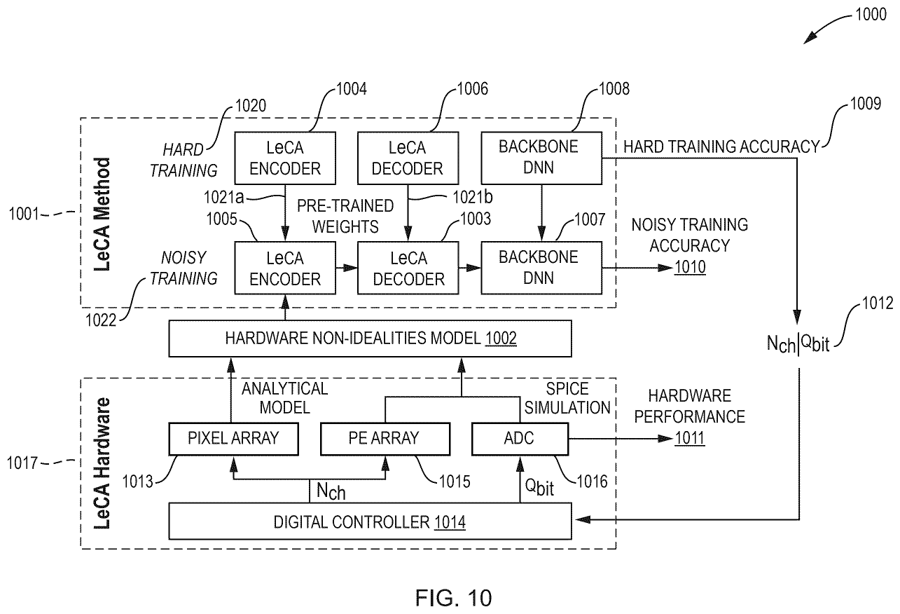

FIG. 10 is a block diagram illustrating a method 1000 for evaluating embodiments. In the method 1000, the performance of method 1001 was validated by hard training 1020, from which the value/range of N_{ch}|Q_{bit} 1012 was determined that achieves optimal tradeoff between compression ratio and downstream accuracy. In method 1001 hard training, 1020, the encoder 1004 and decoder 1006, with their pretrained weights 1021a-b, communicate with the backbone DNN 1008 and output their hard training accuracy results 1009. Further, the pretrained weights 1021a-b from the encoder 1004 and decoder 1006 are utilized in the noisy training 1022 of encoder 1005 and decoder 1003, which communicate with the backbone DNN 1007 to output their noisy training accuracy results 1010. Second, the hardware 1017 is configured by the N_{ch}|Q_{bit} 1012 from the hard training accuracy 1009. Specifically, the N_{ch} from the digital controller 1014 is used to configure the pixel array 1013 and the PE array 1015 for repetitive readout, and the Q_{bit} is used to configure the ADC's 1016 quantization resolution. The hardware performance is then evaluated through transistor-level simulation and the hardware non-idealities model 1002 is extracted. Third, the noisy training 1022 is set up to get noisy training accuracy 1010 by initializing with the pre-trained weights 1021a-b from the hard training 1020 and incorporating the extracted hardware non-idealities model. Note that the parameters of the backbone DNN 1007 are always frozen in such an embodiment.

Embodiments have the ability to retain high downstream accuracy at high compression ratios due to their ability to jointly remove redundancy across the spatial domain, color domain, and bit-depth resolution. In testing baselines, decomposition (SD) and quantization (LR) are typical methods to remove the redundancy in the spatial domain and bit-depth resolution, respectively.

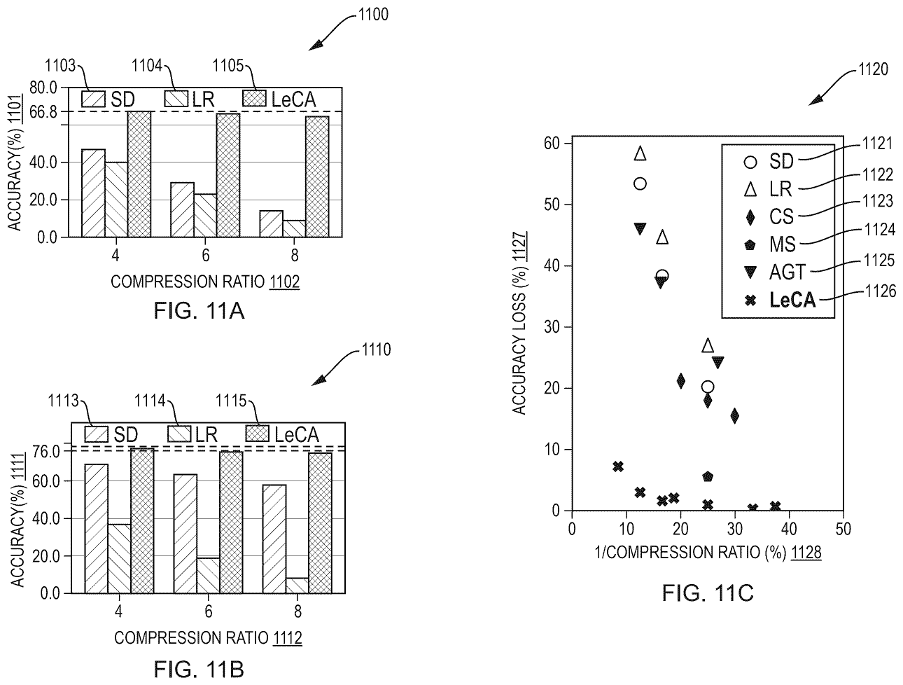

FIG. 11A is a plot 1100 of downstream classification accuracy of ResNet18 1101 versus compression ratio 1102 of images from TinyImageNet compressed by existing methods SD 1103 and LR 1104, and an embodiment 1105 (“LeCA”) of the present disclosure. Plot 1100 of FIG. 11A plots accuracy 1101 over compression ratio 1102 for CR∈{4×, 6×, 8×} for SD 1103, LR 1104 and an embodiment 1105, on the proxy TinyImageNet dataset. As previously indicated, “proxy” refers to the TinyImageNet [69] dataset on a ResNet [70] downstream model being used as a preliminary, timesaving, “proxy” experiment testbed, prior to performing experiments on ImageNet.

FIG. 11B is a plot 1110 of downstream classification accuracy of ResNet50 1111 versus compression ratio 1112 of images from ImageNet compressed by existing methods SD 1113 and LR 1114, and an embodiment 1115 (“LeCA”) of the present disclosure. Plot 1110 of FIG. 11B plots accuracy 1111 over compression ratio 1112 for CR∈{4, 6, 8} for SD 1113, LR 1114, and an embodiment 1115, on ImageNet.

For SD evaluation 1103 and 1113, a 2×2, 2×3, and 2×4 average pooling kernel with corresponding up-sampling through bilinear interpolation was used to acquire compression ratios of 4×, 6×, and 8×, respectively (using Equation (1)). For LR evaluation 1104 and 1114, 3-bit, 1.5-bit (ternary), and 1-bit quantization was performed to achieve compression ratios of 4, 6, and 8 respectively. As can be seen in both plots 1100 and 1110, embodiments (results 1105) outperform its predecessors in all three compression ratio categories. Embodiments attain accuracies of 75.05%, 75.04% and 74.01% (1115) for 4×, 6×, and 8× compression 1112 respectively which translates to 0.97%, 0.98% and 2.01% accuracy loss with respect to the baseline accuracy of 76.02%. An important observation is that embodiments overall lose less accuracy on ImageNet (results 1115 in plot 1110), than on TinylmageNet (results 1105 in plot 1100), especially when performing aggressive compression. This may be because ImageNet's larger image sizes (224×224 as compared to 64×64) allows embodiments to generate larger encoded images which contain more information.

FIG. 11C is a plot 1120 illustrating a comparison of embodiments (1126) with existing methods (1121-1125) on the proxy pipeline (i.e., the overall pipeline involving the TinylmageNet “proxy” dataset). Specifically, 1120 shows accuracy loss percentage 1127 versus 1/compression ratio percentage 1128 for SD 1121, LR 1122, CS 1123, Microshift (MS) [91] 1124, AGT 1125, and an embodiment 1126. Plot 1127 illustrates how the compression ratio 1128 of an embodiment 1126 can be flexibly changed over a large ratio range (See plot 510 of FIG. 5B showing a spread of compression ratios and corresponding Nch and Qbit configurations) by adjusting N_{ch} and Q_{bit} (See Equation (1)). Plot 1120 also shows that an embodiment 1126 outperforms all the baseline methods 1121-1125. At a compression of 25% (CR=4), MS 1124 and CS 1123 have an accuracy loss of 5.3% and 18% respectively, whereas an embodiment 1126 loses <1% accuracy, highlighting the advantage of such an embodiment's task-specific training. A common trend seen is that aggressive compression leads to higher accuracy loss. This is trivial because all models perform lossy compression, meaning that increasing information is irrevocably lost with higher compression.

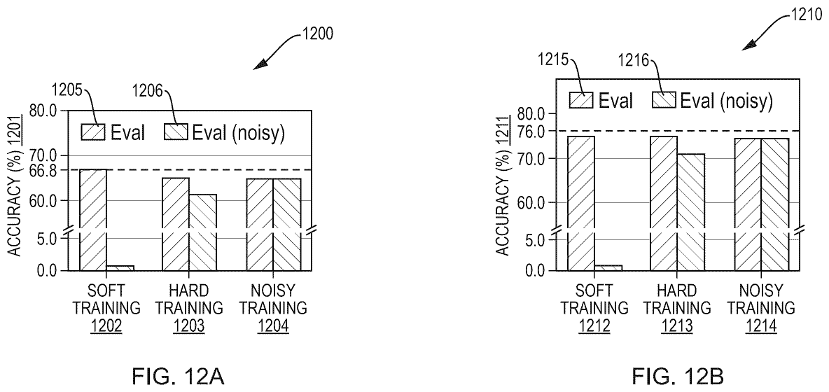

FIGS. 12A and 12B are plots 1200 and 1210, respectively, illustrating accuracy percentage of different training modalities, i.e., soft, hard, and noisy, for proxy (FIG. 12A, plot 1200) and ImageNet (FIG. 12B plot 1210). Plot 1200 of FIG. 12A shows accuracy percentage 1201 of eval 1205 and noisy eval 1206 when implemented with soft training 1202, hard training 1203, and noisy training 1204. According to an embodiment, “eval 1205” refers to an idealistic representation of the pipeline and “eval noisy 1206” refers to a more realistic representation of the pipeline that includes modeled hardware non-idealities, e.g., noise. Plot 1210 of FIG. 12B shows accuracy percentage 1211 of eval 1215 and noisy eval 1216 when implemented with soft training 1212, hard training 1213, and noisy training 1214. An embodiment strives to attain high noisy eval 1206, while at the same time maximizing the compression ratio. The Eval(*) 1205 and 1215 results, and Eval(noisy) 1206 and 1216 results show the validation accuracy on the corresponding modalities (e.g., soft 1202/1212, hard 1203/1213, and noisy 1204/1214 training) and on the full hardware with non-idealities, respectively. Soft training 1202/1212 illustrates good performance with <1% accuracy loss on both datasets. However, learned soft weights were mapped to the hard (analytical hardware) modality 1203/1213 and there was a large accuracy drop. This implies that there was no trivial method to map soft 1202/1212 to hard 1203/1213. With hard training 1203 and 1213, embodiments received accuracies 1201 and 1211 that were on par with the purely soft training 1202 and 1212 (−1.1% and −0.01% accuracy loss for proxy and ImageNet with respect to soft respectively). However, embodiments lose some accuracy (˜4% in both cases) when these learned weights were used and mapped to the noisy modality 1206 and 1216 for the hard training 1203/1213. The noisy training 1204/1214 results illustrate that finetuning the hard 1203/1213 model helped recover most of the accuracy lost due to noise. It was found that directly training the hard 1203/1213 model was insufficient for embodiments to converge to a good optimum on the noisy modality 1206/1216 and that finetuning was indeed important. Overall, this highlights the novelty and noise-resilience of the training according to an embodiment, where even with most of the hardware non-idealities, such an embodiment is able to achieve negligible accuracy loss.

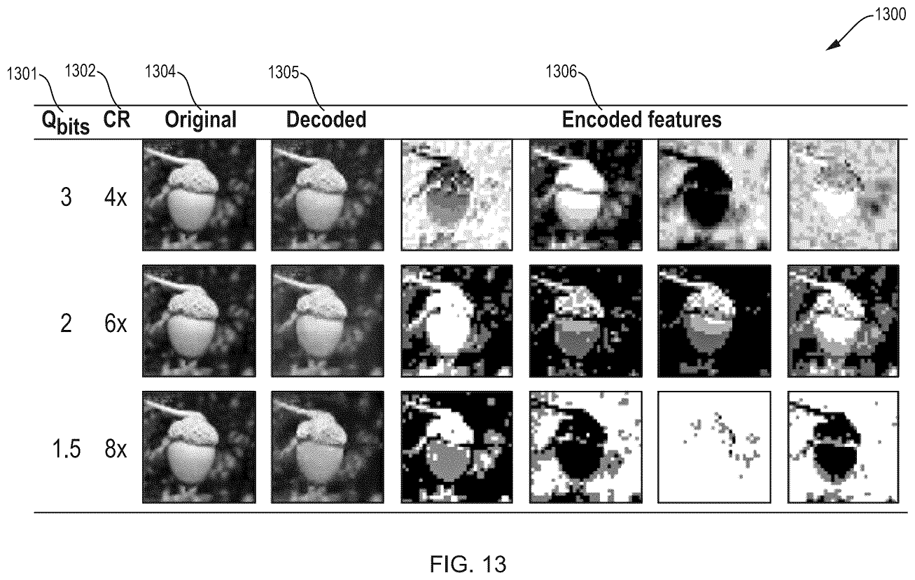

FIG. 13 is a chart 1300 illustrating encoded 1306 and decoded 1305 features generated by an embodiment. The original sample image 1304 is from TinylmageNet, and demonstrates qualitatively what the encoded 1306 and decoded 1305 features look like at each compression ratio 1302 and Q_{bit} 1301. A key observation of this visualization 1300 is that despite an embodiment's encoder-decoder being trained on cross-entropy loss to maximize downstream accuracy, the decoded image 1305 structurally looks similar to the original image 1304. The perceived visual quality decays as more aggressive quantization 1301 is used.

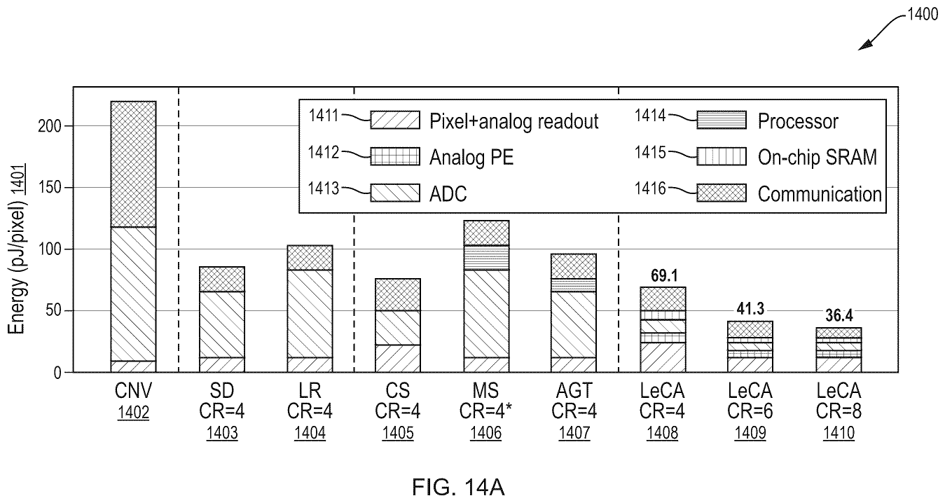

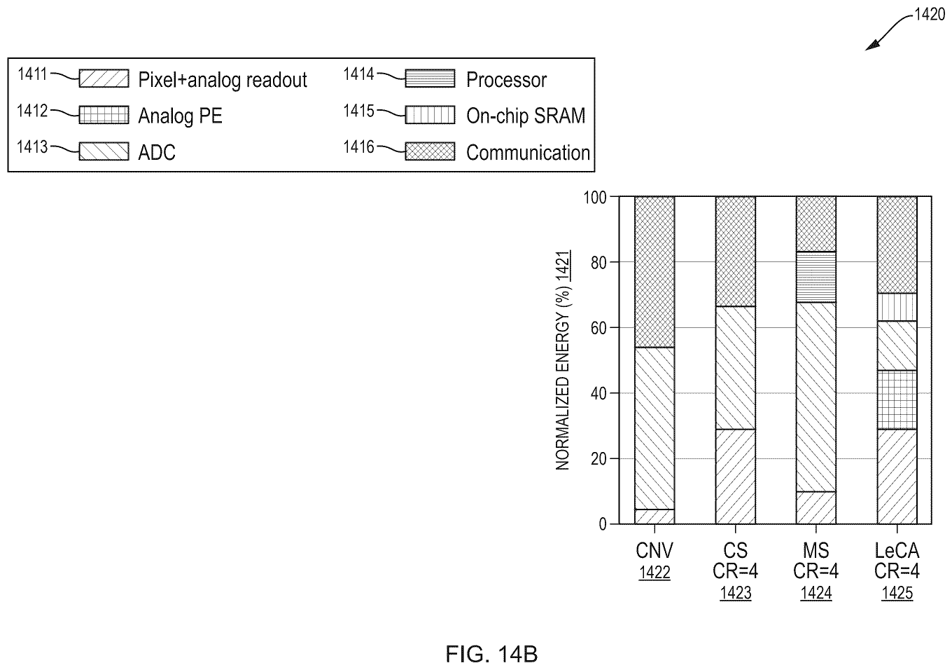

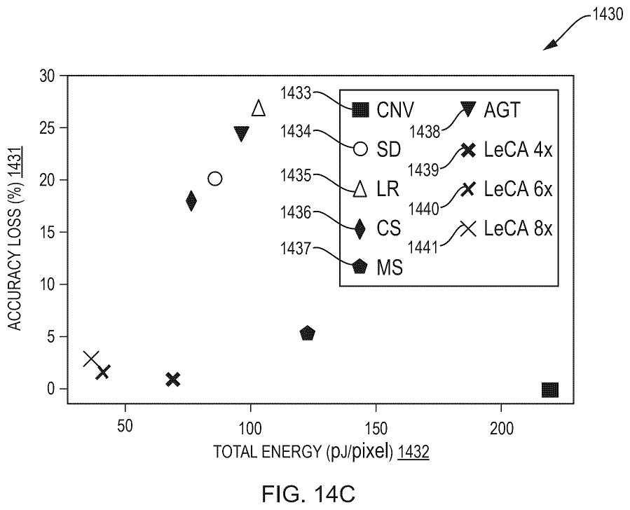

FIGS. 14A-14C are plots 1400, 1420, and 1430, respectively, illustrating energy consumption, normalized energy, and accuracy of conventional, compressive, and embodiment sensors. Plot 1400 of FIG. 14A shows the absolute energy 1401 consumption breakdown between pixel+analog readout 1411, analog PE 1412, ADC 1413, processor 1414, on-chip SRAM 1415, and communication 1416 for CNV 1402 (e.g., a CIS), SD 1403, LR 1404, CS 1405, run-length encoding (MS) 1406, AGT 1407, and embodiments with a compression ratio of 4× 1408, 6× 1409, and 8× 1410. As can be seen by plot 1400, sensor embodiments (1408-1410) achieve extremely-low energy consumption 1401. Compared to CNV 1402, the energy of ADC 1413 and communication 1416 in an embodiment sensor 1408 (CR=4) is dramatically reduced by 10.1× and 5×, respectively, due to analog domain image compression and low-resolution ADC. Comparing to the CNV with SD 1403 and LR 1404 compression techniques under the same compression ratio, the energy of ADC 1413 in an embodiment sensor 1408 (CR=4) is still reduced by 5× and 6.6× because SD 1403 only has compression in spatial domain while LR 1404 only has compression in bit-depth domain. Comparing to the CNV with learned compression techniques (CS 1405, MS 1406, and AGT 1407) under the same compression ratio, a sensor embodiment (1408) consumes 11%, 57%, and 31% less energy, respectively.

FIG. 14B is a plot 1420 illustrating normalized energy percentage 1421 breakdown of CNV 1422, CS 1423, MS 1424, and an embodiment 1425 for the pixel+analog readout 1411, analog PE 1412, ADC 1413, processor 1414, on-chip SRAM 1415, and communication 1416. For CS 1423, excessive energy 1421 is consumed by ADC 1413 due to the requirement on high quantization resolution in a CS 1423 method [6]. Because MS 1424 is implemented in the digital domain pixel-wise A/D conversion 1413 consumes excessive energy, even though the quantization resolution is as low as 2-bit. In an embodiment 1425 (CR=4), neither analog PE 1412 nor ADC 1413 is the energy bottleneck. Embodiments with higher compression ratios, e.g., CR=6 or CR=8 gain more energy savings from non-repetitive pixel readout and less off-chip communication. Specifically, an embodiment with CR=8 is 6.3× and 2.2× more energy efficient than CNV and CS, respectively.

FIG. 14C is a plot 1430 illustrating the tradeoff between sensor chip energy 1432 and downstream task accuracy 1431 for CNV 1433, SD 1434, LR 1435, CS 1436, MS 1437, AGT 1438, and embodiments with 4× 1439, 6× 1440, and 8× 1441 compression. In line with expectations, lower energy is gained in exchange of higher accuracy loss. However, an embodiment defines the optimal Pareto frontier by achieving extremely-low energy consumption while maintaining the lowest accuracy loss. An encoder circuit according to an embodiment occupies 1.1 mm² (0.85 mm² is ADC area) based on layout estimate. Considering that the conventional CIS would minimally include the pixel array (5 mm² for 5 μm pitched pixel) and the ADC, the area overhead of such an embodiment is less than 5%.

With respect to task accuracy 1431, these evaluations assume a downstream model with frozen weights. However, by unfreezing the downstream model, experiments have shown 0.02% and 0.78% accuracy loss for 4× 1439 and 8× 1441 compression, respectively, which are well within standard metrics (<1%) proposed by benchmarks like MLPerf [82]. This suggests that there are avenues to further improve and close the gap with the state-of-the-art task accuracy, at the cost of longer training time and the complexity to adapt the weights of an entire vision pipeline.

Regarding image resolution, both the hardware and methods of embodiments support higher-resolution images. Embodiments may adopt column-parallel PE arrays where the physical width of the PE and ADC matches four pixel columns, allowing such embodiments to scale with the pixel array width to accommodate higher-resolution inputs. Embodiments can achieve up to 86 fps frame rate with 1080p resolution, comfortably supporting moving object recording (at 60 fps). These results indicate comparable performance from TinyImageNet (64×64) and ImageNet (224×224), suggesting embodiment's work across varying resolutions and the trend continues for high-resolution inputs.

This evaluation has included standard compression techniques such as spatial gradients (i.e., AGT), run-length encoding (MS), and quantization (LR). JPEG was also performed and sees a 0.51% accuracy loss at 5.07× compression, with an embodiment's 0.98% accuracy at 6×. Critically, it is emphasized that embodiments achieve outstanding compression/accuracy performance on top of sizable sensor energy saving, while standard digital compression invariably requires significant additional hardware and energy to perform.

Regarding system deployment, embodiments can adapt to downstream tasks beyond image classification by following the same training/finetuning process with no change to the hardware. Embodiments allow for a configurable number of feature channels and quantization levels to provide flexible compression/accuracy tradeoff. The trained encoding parameters instantiated in the PE are re-programmable according to the downstream task. Therefore, embodiments disclose a practical solution with broad applications. Intuitively, capturing a smaller image directly translates to reduced memory storage and fewer communication and computing powers in the later processing stages of the machine vision pipeline.

Computational CIS for DNN—prior computational CIS works offload the first layer [51], [83a-b] or the first few layers [5], [84] of a DNN in the sensor chip. However, these works do not explicitly leverage data compression brought by the DNN offloading to improve the sensor's energy efficiency. Recent study has also considered optimizing the ISP design jointly with the downstream CV tasks [85]-[87]. Nonetheless, these computational approaches after CIS digitization do not translate to sensor resource/energy savings, whereas embodiments implement an encoder to highly compress the data in the analog domain, which results in compression-dependent extremely-low energy consumption.

In-sensor compression—common in-sensor compression techniques either adopt a heuristic compression method [40], [42], [44] or are based on compressive sensing [24], [45]. However, these compression methods are task-agnostic and the compression ratio is related to the PSNR of the reconstructed images and independent of downstream tasks. Instead, a sensor according to an embodiment encodes the image to a task-specific representation so that there exists a clear tradeoff between the compression ratio and the downstream task accuracy.

Learned compression. Learning-based image compression has been increasingly popular since the advent of neural networks [88], [89]. Most models use an autoencoder structure that can compress an image by 80˜100× while maintaining high visual quality [31]-[33]. Adjacent to the autoencoder approach, generative adversarial networks [20], [90] have been proposed to synthesize details the model cannot afford to store. However, these models use computation-intensive encoder networks which are infeasible to be incorporated into the CIS. Embodiments may also use an encoder-decoder structure, but implement the encoder in the analog domain with extremely-low overhead while also maintaining the lightweight decoder (i.e., the decoder is lightweight (computationally) compared to a full downstream CV model, meaning the decoder has low overhead).

Embodiments or aspects thereof may be implemented in the form of hardware, firmware, or software. If implemented in software, the software may be stored on any non-transient computer readable medium that is configured to enable a processor to load the software or subsets of instructions thereof. The processor then executes the instructions and is configured to operate or cause an apparatus to operate in a manner as described herein.

Further, firmware, software, routines, or instructions may be described herein as performing certain actions and/or functions of the data processors. However, it should be appreciated that such descriptions contained herein are merely for convenience and that such actions in fact result from computing devices, processors, controllers, or other devices executing the firmware, software, routines, instructions, etc.

It should be understood that the flow diagrams, block diagrams, and network diagrams may include more or fewer elements, be arranged differently, or be represented differently. But it further should be understood that certain implementations may dictate the block and network diagrams and the number of block and network diagrams illustrating the execution of the embodiments be implemented in a particular way.

Accordingly, further embodiments may also be implemented in a variety of computer architectures, physical, virtual, cloud computers, and/or some combination thereof, and thus, the data processors described herein are intended for purposes of illustration only and not as a limitation of the embodiments.

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

### REFERENCES

[1] Sven Fleck and Wolfgang Straßer. Smart camera based monitoring system and its application to assisted living. Proceedings of the IEEE, 96(10):1698-1714, 2008.
[2] Nicholas D. Lane, Emiliano Miluzzo, Hong Lu, Daniel Peebles, Tanzeem Choudhury, and Andrew T. Campbell. A survey of mobile phone sensing. IEEE Communications Magazine, 48(9):140-150, 2010.
[3]L. Verger, M. C. Gentet, L. Gerfault, R. Guillemaud, C. Mestais, O. Monnet, G. Montemont, G. Petroz, J. P. Rostaing, and J. Rustique. Performance and perspectives of a cdznte-based gamma camera for medical imaging. IEEE Transactions on Nuclear Science, 51(6):3111-3117, 2004.
[4]Z. Chen, H. Zhu, E. Ren, Z. Liu, K. Jia, L. Luo, X. Zhang, Q. Wei, F. Qiao, X. Liu, and H. Yang. Processing near sensor architecture in mixed-signal domain with cmos image sensor of convolutional-kernel-readout method. IEEE Transactions on Circuits and Systems I: Regular Papers, 67(2):389-400, 2020.
[5]R. LiKamWa, Y. Hou, Y. Gao, M. Polansky, and L. Zhong. Redeye: Analog convnet image sensor architecture for continuous mobile vision. In 2016 ACM/IEEE 43rd Annual International Symposium on Computer Architecture (ISCA), pages 255-266, 2016.
[6] Marco F. Duarte, Mark A. Davenport, Dharmpal Takhar, Jason N. Laska, Ting Sun, Kevin F. Kelly, and Richard G. Baraniuk. Single-pixel imaging via compressive sampling. IEEE Signal Processing Magazine, 25(2):83-91, 2008.
[7] Junan Lee, Himchan Park, Bongsub Song, Kiwoon Kim, Jaeha Eom, Kyunghoon Kim, and Jinwook Burm. High frame-rate vga cmos image sensor using non-memory capacitor two-step single-slope adcs. IEEE Transactions on Circuits and Systems I: Regular Papers, 62(9):2147-2155, 2015.
[8] Injun Park, Woojin Jo, Chanmin Park, Byungchoul Park, Jimin Cheon, and Youngcheol Chae. A 640×640 fully dynamic cmos image sensor for always-on operation. IEEE Journal of Solid-State Circuits, 55(4):898-907, 2020.
[9] Denis Guangyin Chen, Fang Tang, Man-Kay Law, Xiaopeng Zhong, and Amine Bermak. A 64 fj/step 9-bit sar adc array with forward error correction and mixed-signal cds for cmos image sensors. IEEE Transactions on Circuits and Systems I: Regular Papers, 61(11):3085-3093, 2014.
[10] Hyeon-June Kim, Sun-Il Hwang, Ji-Wook Kwon, Dong-Hwan Jin, Byoung-Soo Choi, Sang-Gwon Lee, Jong-Ho Park, Jang-Kyoo Shin, and Seung-Tak Ryu. A delta-readout scheme for low-power cmos image sensors with multi-column-parallel sar adcs. IEEE Journal of Solid-State Circuits, 51(10):2262-2273, 2016.
[11] Sun-Il Hwang, Jae-Hyun Chung, Hyeon-June Kim, Il-Hoon Jang, Min-Jae Seo, Sang-Hyun Cho, Heewon Kang, Minho Kwon, and Seung-Tak Ryu. A 2.7-m pixels 64-mw cmos image sensor with multicolumn-parallel noise-shaping sar adcs. IEEE Transactions on Electron Devices, 65(3):1119-1126, 2018.
[12]K. D. Choo, L. Xu, Y. Kim, J. Seol, X. Wu, D. Sylvester, and D. Blaauw. Energy-efficient motion-triggered iot cmos image sensor with capacitor array-assisted charge-injection sar adc. IEEE Journal of Solid-State Circuits, 54(11):2921-2931, 2019.
[13] Jaehyuk Choi, Seokjun Park, Jihyun Cho, and Euisik Yoon. An energy/illumination-adaptive cmos image sensor with reconfigurable modes of operations. IEEE Journal of Solid-State Circuits, 50(6):1438-1450, 2015.
[14] Jaehyuk Choi, Jungsoon Shin, Dongwu Kang, and Du-Sik Park. Always-on cmos image sensor for mobile and wearable devices. IEEE Journal of Solid-State Circuits, 51(1):130-140, 2016.
[15] Hyeon-June Kim. 11-bit column-parallel single-slope adc with first-step half-reference ramping scheme for high-speed cmos image sensors. IEEE Journal of Solid-State Circuits, 56(7):2132-2141, 2021.
[16] Min-Seok Shin, Jong-Boo Kim, Min-Kyu Kim, Yun-Rae Jo, and Oh-Kyong Kwon. A 1.92-megapixel cmos image sensor with column-parallel low-power and area-efficient sa-adcs. IEEE Transactions on Electron Devices, 59(6):1693-1700, 2012.
[17] Yun-Rae Jo, Seong-Kwan Hong, and Oh-Kyong Kwon. A multi-bit incremental adc based on successive approximation for low noise and high resolution column-parallel readout circuits. IEEE Transactions on Circuits and Systems I: Regular Papers, 62(9):2156-2166, 2015.
[18] Min-Woong Seo, Myunglae Chu, Hyun-Yong Jung, Suksan Kim, Jiyoun Song, Junan Lee, Sung-Yong Kim, Jongyeon Lee, Sung-Jae Byun, Daehee Bae, Minkyung Kim, Gwi-Deok Lee, Heesung Shim, Changy-ong Um, Changhwa Kim, In-Gyu Baek, Doowon Kwon, Hongki Kim, Hyuksoon Choi, Jonghyun Go, JungChak Ahn, Jaekyu Lee, Changrok Moon, Kyupil Lee, and Hyoung-Sub Kim. A 2.6 e-rms low-random-noise, 116.2 mw low-power 2-mp global shutter cmos image sensor with pixel-level adc and in-pixel memory. In 2021 Symposium on VLSI Circuits, pages 1-2, 2021.
[19] Yueyu Hu, Wenhan Yang, Zhan Ma, and Jiaying Liu. Learning end-to-end lossy image compression: A benchmark. IEEE Transactions on Pattern Analysis and Machine Intelligence, 2021.
[20] Eirikur Agustsson, Michael Tschannen, Fabian Mentzer, Radu Timofte, and Luc Van Gool. Generative adversarial networks for extreme learned image compression. In Proceedings of the IEEE/CVF International Conference on Computer Vision, pages 221-231, 2019.
[21] David Minnen, Johannes Ballé, and George D Toderici. Joint autoregres-sive and hierarchical priors for learned image compression. Advances in neural information processing systems, 31, 2018.
[22] Milin Zhang and Amine Bermak. Compressive acquisition cmos image sensor: From the algorithm to hardware implementation. IEEE Trans-actions on Very Large Scale Integration (VLSI) Systems, 18(3):490-500, 2010.
[23] Jian Zhang, Chen Zhao, Debin Zhao, and Wen Gao. Image compressive sensing recovery using adaptively learned sparsifying basis via 10 minimization. Signal Processing, 103:114-126, 2014.
[24] Yusuke Oike and Abbas El Gamal. Cmos image sensor with per-column σδ adc and programmable compressed sensing. IEEE Journal of Solid-State Circuits, 48(1):318-328, 2013.
[25] Hyunkeun Lee, Donghwan Seo, Woo-Tae Kim, and Byung-Geun Lee. A Compressive Sensing-Based CMOS Image Sensor With Second-Order EA ADCs. IEEE Sensors Journal, 18(6):2404-2410, 2018.
[26] Hyunkeun Lee, Woo-Tae Kim, Jinho Kim, Myonglae Chu, and Byung-Geun Lee. A compressive sensing cmos image sensor with partition sampling technique. IEEE Transactions on Industrial Electronics, 68(9):8874-8884, 2021.
[27]B. K. Gunturk, J. Glotzbach, Y. Altunbasak, R. W. Schafer, and R. M. Mersereau. Demosaicking: color filter array interpolation. IEEE Signal Processing Magazine, 22(1):44-54, 2005.
[28] Amir Said and William A Pearlman. An image multiresolution rep-resentation for lossless and lossy compression. IEEE Transactions on image processing, 5(9):1303-1310, 1996.
[29] Jiangtao Wen and John D Villasenor. A class of reversible variable length codes for robust image and video coding. In Proceedings of International Conference on Image Processing, volume 2, pages 65-68. IEEE, 1997.
[30] Gregory K Wallace. The jpeg still picture compression standard. Communications of the ACM, 34(4):30-44, 1991.
[31] Fabian Mentzer, Eirikur Agustsson, Michael Tschannen, Radu Timofte, and Luc Van Gool. Conditional probability models for deep image compression. In 2018 IEEE/CVF Conference on Computer Vision and Pattern Recognition, pages 4394-4402, 2018.
[32] Zhengxue Cheng, Heming Sun, Masaru Takeuchi, and Jiro Katto. Deep convolutional autoencoder-based lossy image compression. In 2018 Picture Coding Symposium (PCS), pages 253-257. IEEE, 2018.
[33] Lei Zhou, Chunlei Cai, Yue Gao, Sanbao Su, and Junmin Wu. Varia-tional autoencoder for low bit-rate image compression. In Proceedings of the IEEE Conference on Computer Vision and Pattern Recognition Workshops, pages 2617-2620, 2018.
[34] Jie Gui, Zhenan Sun, Shuiwang Ji, Dacheng Tao, and Tieniu Tan. Feature selection based on structured sparsity: A comprehensive study. IEEE transactions on neural networks and learning systems, 28(7):1490-1507, 2016.
[35] Alessandro Aimar, Hesham Mostafa, Enrico Calabrese, Antonio Rios-Navarro, Ricardo Tapiador-Morales, Iulia-Alexandra Lungu, Moritz B Milde, Federico Corradi, Alejandro Linares-Barranco, Shih-Chii Liu, et al. Nullhop: A flexible convolutional neural network accelerator based on sparse representations of feature maps. IEEE transactions on neural networks and learning systems, 30(3):644-656, 2018.
[36] Chenzhuo Zhu, Song Han, Huizi Mao, and William J Dally. Trained ternary quantization. arXiv preprint arXiv:1612.01064, 2016.
[37] Shijie Cao, Lingxiao Ma, Wencong Xiao, Chen Zhang, Yunxin Liu, Lintao Zhang, Lanshun Nie, and Zhi Yang. Seernet: Predicting convolu-tional neural network feature-map sparsity through low-bit quantization. In Proceedings of the IEEE/CVF Conference on Computer Vision and Pattern Recognition, pages 11216-11225, 2019.
[38] Tommaso Polonelli, Daniele Battistini, Manuele Rusci, Davide Brunelli, and Luca Benini. An energy optimized jpeg encoder for parallel ultra-low-power processing-platforms. In Applications in Electronics Pervading Industry, Environment and Society: APPLEPIES 2019 7, pages 125-133. Springer, 2020.
[39] Evgeny Belyaev, Kai Liu, Moncef Gabbouj, and YunSong Li. An efficient adaptive binary range coder and its vlsi architecture. IEEE transactions on circuits and systems for video technology, 25(8):1435-1446, 2014.
[40] Milin Zhang and Amine Bermak. Cmos image sensor with on-chip image compression: A review and performance analysis. Journal of sensors, 2010:1-17, 2010.
[41] Denis Guangyin Chen, Fang Tang, Man-Kay Law, and Amine Bermak. A 12 pj/pixel analog-to-information converter based 816×640 pixel cmos image sensor. IEEE Journal of Solid-State Circuits, 49(5):1210-1222, 2014.
[42] Bo Zhang, Pedro V. Sander, Chi-Ying Tsui, and Amine Bermak. Microshift: An efficient image compression algorithm for hardware. IEEE Transactions on Circuits and Systems for Video Technology, 29(11):3430-3443, 2019.
[43] Christopher Young, Alex Omid-Zohoor, Pedram Lajevardi, and Boris Murmann. A data-compressive 1.5/2.75-bit log-gradient qvga image sensor with multi-scale readout for always-on object detection. IEEE Journal of Solid-State Circuits, 54(11):2932-2946, 2019.
[44] Amandeep Kaur, Deepak Mishra, K. M. Amogh, and Mukul Sarkar. On-array compressive acquisition in cmos image sensors using accumulated spatial gradients. IEEE Transactions on Circuits and Systems for Video Technology, 31(2):523-532, 2021.
[45] Chanmin Park, Wenda Zhao, Injun Park, Nan Sun, and Youngcheol Chae. A 51-pj/pixel 33.7-db psnr 4× compressive cmos image sensor with column-parallel single-shot compressive sensing. IEEE Journal of Solid-State Circuits, 56, 8 (2021), 2503-2515.
[46] Alain Hore and Djemel Ziou. Image quality metrics: Psnr vs. ssim. In 2010 20th international conference on pattern recognition, pages 2366-2369. IEEE, 2010.
[47] Felix Heide, Markus Steinberger, Yun-Ta Tsai, Mushfiqur Rouf, Dawid Paj, ak, Dikpal Reddy, Orazio Gallo, Jing Liu, Wolfgang Heidrich, Karen Egiazarian, et al. Flexisp: A flexible camera image processing framework. ACM Transactions on Graphics (ToG), 33(6):1-13, 2014.
[48] Laurent Millet, Stephane Chevobbe, Caaliph Andriamisaina, Lamine Benaissa, Edouard Deschaseaux, Edith Beigne, Karim Ben Chehida, Maria Lepecq, Mehdi Darouich, Fabrice Guellec, Thomas Dombek, and Marc Duranton. A 5500-frames/s 85-gops/w 3-d stacked bsi vision chip based on parallel in-focal-plane acquisition and processing. IEEE Journal of Solid-State Circuits, 54(4):1096-1105, 2019.
[49] Christoph Posch, Daniel Matolin, and Rainer Wohlgenannt. A qvga 143 db dynamic range frame-free pwm image sensor with lossless pixel-level video compression and time-domain cds. IEEE Journal of Solid-State Circuits, 46(1):259-275, 2010.
[50] Vahid Majidzadeh, Laurent Jacques, Alexandre Schmid, Pierre Van-dergheynst, and Yusuf Leblebici. A (256×256) pixel 76.7 mw cmos imager/compressor based on real-time in-pixel compressive sensing. In Proceedings of 2010 IEEE International Symposium on Circuits and Systems, pages 2956-2959. IEEE, 2010.
[51] Han Xu, Ningchao Lin, Li Luo, Qi Wei, Runsheng Wang, Cheng Zhuo, Xunzhao Yin, Fei Qiao, and Huazhong Yang. Senputing: An ultra-low-power always-on vision perception chip featuring the deep fusion of sensing and computing. IEEE Transactions on Circuits and Systems I: Regular Papers, 69(1):232-243, 2021.
[52] Yi Luo and Shahriar Mirabbasi. Always-on cmos image sensor pixel design for pixel-wise binary coded exposure. In 2017 IEEE International Symposium on Circuits and Systems (ISCAS), pages 1-4. IEEE, 2017.
[53] Bin Zhang, Kuizhi Mei, and Nanning Zheng. Reconfigurable processor for binary image processing. IEEE Transactions on Circuits and Systems for Video Technology, 23(5):823-831, 2013.
[54]H Tsugawa, H Takahashi, R Nakamura, T Umebayashi, T Ogita, H Okano, K Iwase, H Kawashima, T Yamasaki, D Yoneyama, et al. Pixel/dram/logic 3-layer stacked cmos image sensor technology. In 2017 IEEE International Electron Devices Meeting (IEDM), pages 3-2. IEEE, 2017.
[55] Minho Kwon, Seunghyun Lim, Hyeokjong Lee, Il-Seon Ha, Moo-Young Kim, Il-Jin Seo, Suho Lee, Yongsuk Choi, Kyunghoon Kim, Hansoo Lee, et al. A low-power 65/14 nm stacked cmos image sensor. In 2020 IEEE International Symposium on Circuits and Systems (ISCAS), pages 1-4. IEEE, 2020.
[56] Chiao Liu, Song Chen, Tsung-Hsun Tsai, Barbara De Salvo, and Jorge Gomez. Augmented reality-the next frontier of image sensors and compute systems. In 2022 IEEE International Solid-State Circuits Conference (ISSCC), volume 65, pages 426-428. IEEE, 2022.
[57] Vincent C Venezia, Alan Chih-Wei Hsiung, Wu-Zang Yang, Yuying Zhang, Cheng Zhao, Zhiqiang Lin, and Lindsay A Grant. Second generation small pixel technology using hybrid bond stacking. Sensors, 18(2):667, 2018.
[58] Masaya Kawano, Xiangy-Yu Wang, and Qin Ren. New cost-effective via-last approach by “one-step tsv” after wafer stacking for 3d memory applications. In 2019 IEEE 69th Electronic Components and Technology Conference (ECTC), pages 1996-2002. IEEE, 2019.
[59] Kyeongryeol Bong, Sungpill Choi, Changhyeon Kim, Donghyeon Han, and Hoi-Jun Yoo. A low-power convolutional neural network face recognition processor and a cis integrated with always-on face detector. IEEE Journal of Solid-State Circuits, 53(1):115-123, 2017.
[60] Wissam Benjilali, William Guicquero, Laurent Jacques, and Gilles Sicard. An analog-to-information vga image sensor architecture for support vector machine on compressive measurements. In 2019 IEEE International Symposium on Circuits and Systems (ISCAS), pages 1-5. IEEE, 2019.
[61] Ryan Robucci, Jordan D. Gray, Leung Kin Chiu, Justin Romberg, and Paul Hasler. Compressive sensing on a cmos separable-transform image sensor. Proceedings of the IEEE, 98(6):1089-1101, 2010.
[62] Zheyu Liu, Erxiang Ren, Fei Qiao, Qi Wei, Xinjun Liu, Li Luo, Huichan Zhao, and Huazhong Yang. Ns-cim: A current-mode computation-in-memory architecture enabling near-sensor processing for intelligent iot vision nodes. IEEE Transactions on Circuits and Systems I: Regular Papers, 67(9):2909-2922, 2020.
[63]L. Jacques, P. Vandergheynst, A. Bibet, V. Majidzadeh, A. Schmid, and Y. Leblebici. Cmos compressed imaging by random convolution. In 2009 IEEE International Conference on Acoustics, Speech and Signal Processing, pages 1113-1116, 2009.
[64]E. H. Lee and S. S. Wong. Analysis and design of a passive switched-capacitor matrix multiplier for approximate computing. IEEE Journal of Solid-State Circuits, 52(1):261-271, 2017.
[65] Diederik P Kingma, Max Welling, et al. An introduction to varia-tional autoencoders. Foundations and Trends® in Machine Learning, 12(4):307-392, 2019.
[66] Sheng Li, Zhong Ma, Zhonglin Cao, Lijia Pan, and Yi Shi. Ad-vanced wearable microfluidic sensors for healthcare monitoring. Small, 16(9):1903822, 2020.
[67] Piotr Dollár, Mannat Singh, and Ross Girshick. Fast and accurate model scaling. In Proceedings of the IEEE/CVF Conference on Computer Vision and Pattern Recognition, pages 924-932, 2021.
[68] Kai Zhang, Wangmeng Zuo, Yunjin Chen, Deyu Meng, and Lei Zhang. Beyond a gaussian denoiser: Residual learning of deep cnn for image denoising. IEEE Transactions on Image Processing, 26(7):3142-3155, 2017.
[69] Ya Le and Xuan Yang. Tiny imagenet visual recognition challenge. CS 231N, 7(7):3, 2015.
[70] Kaiming He, Xiangyu Zhang, Shaoqing Ren, and Jian Sun. Deep residual learning for image recognition. In Proceedings of the IEEE Conference on Computer Vision and Pattern Recognition (CVPR), June 2016.
[71] Siwei Ma, Xinfeng Zhang, Chuanmin Jia, Zhenghui Zhao, Shiqi Wang, and Shanshe Wang. Image and video compression with neural networks: A review. IEEE Transactions on Circuits and Systems for Video Technology, 30(6):1683-1698, 2019.
[72] Vinay Joshi, Manuel Le Gallo, Simon Haefeli, Irem Boybat, Sasid-haran Rajalekshmi Nandakumar, Christophe Piveteau, Martino Dazzi, Bipin Rajendran, Abu Sebastian, and Evangelos Eleftheriou. Accurate deep neural network inference using computational phase-change memory. Nature communications, 11(1):2473, 2020.
[73] Chuteng Zhou, Fernando Garcia Redondo, Julian Buchel, Irem Boybat, Xavier Timoneda Comas, SR Nandakumar, Shidhartha Das, Abu Se-bastian, Manuel Le Gallo, and Paul N Whatmough. Analognets: Ml-hw co-design of noise-robust tinyml models and always-on analog compute-in-memory accelerator. arXiv preprint arXiv:2111.06503, 2021.
[74] Yoshua Bengio, Nicholas Léonard, and Aaron Courville. Estimating or propagating gradients through stochastic neurons for conditional computation. arXiv preprint arXiv:1308.3432, 2013.
[75] Rituraj Singh, Stevo Bailey, Phillip Chang, Ashkan Olyaei, Mohammad Hekmat, and Renaldi Winoto. 34.2 a 21 pj/frame/pixel imager and 34 pj/frame/pixel image processor for a low-vision augmented-reality smart contact lens. In 2021 IEEE International Solid-State Circuits Conference (ISSCC), volume 64, pages 482-484, 2021.
[76] Wenjuan Guo and Nan Sun. A 12b-enob 61μw noise-shaping sar adc with a passive integrator. In ESSCIRC Conference 2016: 42nd European Solid-State Circuits Conference, pages 405-408, 2016.
[77] Chun-Cheng Liu, Soon-Jyh Chang, Guan-Ying Huang, and Ying-Zu Lin. A 10-bit 50-ms/s sar adc with a monotonic capacitor switching procedure. IEEE Journal of Solid-State Circuits, 45(4):731-740, 2010.
[78]R. G. Carvajal, J. Ramirez-Angulo, A. J. Lopez-Martin, A. Torralba, J. A. G. Galan, A. Carlosena, and F. M. Chavero. The flipped voltage follower: a useful cell for low-voltage low-power circuit design. IEEE Transactions on Circuits and Systems I: Regular Papers, 52(7):1276-1291, 2005.
[79] Jia Deng, Wei Dong, Richard Socher, Li-Jia Li, Kai Li, and Li Fei-Fei. Imagenet: A large-scale hierarchical image database. In 2009 IEEE conference on computer vision and pattern recognition, pages 248-255. Ieee, 2009.
[80] Adam Paszke, Sam Gross, Francisco Massa, Adam Lerer, James Brad-bury, Gregory Chanan, Trevor Killeen, Zeming Lin, Natalia Gimelshein, Luca Antiga, et al. Pytorch: An imperative style, high-performance deep learning library. Advances in neural information processing systems, 32, 2019.
[81] Diederik P Kingma and Jimmy Ba. Adam: A method for stochastic optimization. arXiv preprint arXiv:1412.6980, 2014.
[82] Vijay Janapa Reddi, Christine Cheng, David Kanter, Peter Mattson, Guenther Schmuelling, Carole-Jean Wu, Brian Anderson, Maximilien Breughe, Mark Charlebois, William Chou, et al. Mlperf inference benchmark. In 2020 ACM/IEEE 47th Annual International Symposium on Computer Architecture (ISCA), pages 446-459. IEEE, 2020.
[83a] Tzu-Hsiang Hsu, Yen-Kai Chen, Tai-Hsing Wen, Wei-Chen Wei, Yi-Ren Chen, Fu-Chun Chang, Hyunjoon Kim, Qian Chen, Bongjin Kim, Ren-Shuo Liu, Chung-Chuan Lo, Kea-Tiong Tang, Meng-Fan Chang, and Chih-Cheng Hsieh. A 0.5 v real-time computational cmos image sensor with programmable kernel for always-on feature extraction. In 2019 IEEE Asian Solid-State Circuits Conference (A-SSCC), pages 33-34, 2019.
[83b] Tzu-Hsiang Hsu, Yi-Ren Chen, Ren-Shuo Liu, Chung-Chuan Lo, Kea-Tiong Tang, Meng-Fan Chang, and Chih-Cheng Hsieh. 2020. A 0.5-V real-time computational CMOS image sensor with programmable kernel for feature extraction. IEEE Journal of Solid-State Circuits 56, 5 (2020), 1588-1596.
[84] Tzu-Hsiang Hsu, Guan-Cheng Chen, Yi-Ren Chen, Chung-Chuan Lo, Ren-Shuo Liu, Meng-Fan Chang, Kea-Tiong Tang, and Chih-Cheng Hsieh. A 0.8 v intelligent vision sensor with tiny convolutional neural network and programmable weights using mixed-mode processing-in-sensor technique for image classification. In 2022 IEEE International Solid-State Circuits Conference (ISSCC), volume 65, pages 1-3. IEEE, 2022.
[85] Chyuan-Tyng Wu, Leo F Isikdogan, Sushma Rao, Bhavin Nayak, Timo Gerasimow, Aleksandar Sutic, Liron Ain-kedem, and Gilad Michael. Visionisp: Repurposing the image signal processor for computer vision applications. In 2019 IEEE International Conference on Image Processing (ICIP), pages 4624-4628. IEEE, 2019.
[86] Mark Buckler, Suren Jayasuriya, and Adrian Sampson. Reconfiguring the imaging pipeline for computer vision. In Proceedings of the IEEE International Conference on Computer Vision, pages 975-984, 2017.
[87] Patrick Hansen, Alexey Vilkin, Yury Khrustalev, James Imber, David Hanwell, Matthew Mattina, and Paul N Whatmough. Isp4 ml: Under-standing the role of image signal processing in efficient deep learning vision systems. arXiv preprint arXiv:1911.07954, 2019.
[88] Michael Egmont-Petersen, Dick de Ridder, and Heinz Handels. Im-age processing with neural networks-a review. Pattern recognition, 35(10):2279-2301, 2002.
[89]J Jiang. Image compression with neural networks-a survey. Signal processing: image Communication, 14(9):737-760, 1999.
[90] Ian Goodfellow, Jean Pouget-Abadie, Mehdi Mirza, Bing Xu, David Warde-Farley, Sherjil Ozair, Aaron Courville, and Yoshua Bengio. Gen-erative adversarial networks. Communications of the ACM, 63(11):139-144, 2020.
[91] Microshift: Bo Zhang, Pedro V Sander, Chi-Ying Tsui, and Amine Bermak. 2018. Microshift: An efficient image compression algorithm for hardware. IEEE Transactions on Circuits and Systems for Video Technology 29, 11 (2018), 3430-3443.
[92] Weidong Cao, Yilong Zhao, Adith Boloor, Yinhe Han, Xuan Zhang, and Li Jiang. 2021. Neural-PIM: Efficient processing-in-memory with neural approximation of peripherals. IEEE Trans. Comput. 71, 9 (2021), 2142-2155.

What is claimed is:

1. A method for compressing image data, the method comprising:
receiving analog image data comprising an array of pixel exposure values representing an image;
convolving the analog image data received with at least one programmable kernel to produce an array of scalar values; and
quantizing the array of scalar values to generate a quantized feature map, wherein the quantized feature map is a compressed representation of the image relative to the analog image data received.

2. The method of claim 1, wherein the receiving, convolving, and quantizing are implemented by an encoder packaged within an image sensor.

3. The method of claim 2, further comprising, by a pixel array packaged within the image sensor:
capturing the image; and
transmitting, to the encoder, the analog image data comprising the array of pixel exposure values representing the image.

4. The method of claim 1, wherein the convolving the analog image data received with the at least one programmable kernel comprises condensing a subset of values from the array of pixel exposure values received into a single scalar value of the array of scalar values.

5. The method of claim 1, further comprising:
identifying at least one feature, of the image, in the quantized feature map;
deconvolving the at least one feature identified to produce a partially deconvolved feature map with dimensions equal to dimensions of the image; and
transmitting the partially deconvolved feature map produced to a computer vision (CV) model.

6. The method of claim 1, further comprising cooperatively training: (i) the at least one programmable kernel, and (ii) a computer vision (CV) model.

7. The method of claim 6, wherein the cooperatively training comprises:
freezing a weight associated with the CV model; and
training a pipeline composed of the at least one programmable kernel and the CV model with the weight frozen, wherein the training the pipeline comprises adjusting a weight of the at least one programmable kernel and maintaining the weight frozen associated with the CV model.

8. The method of claim 6, wherein the CV model is a deep neural network (DNN).

9. The method of claim 1, further comprising transmitting the quantized feature map to a CV model.

10. A system for compressing image data, the system comprising:
a pixel array configured to capture an image; and
an encoder configured to:
receive, from the pixel array, analog image data comprising an array of pixel exposure values representing the image;
convolve the analog image data received with at least one programmable kernel to produce an array of scalar values; and
quantize the array of scalar values to generate a quantized feature map, wherein the quantized feature map is a compressed representation of the image relative to the analog image data received.

11. The system of claim 10, further comprising an image sensor, the image sensor comprising the encoder and the pixel array.

12. The system of claim 10, wherein the pixel array is further configured to transmit, to the encoder, the analog image data comprising the array of pixel exposure values representing the image.

13. The system of claim 10, wherein, to convolve the analog image data received with the at least one programmable kernel, the encoder is configured to condense a subset of values from the array of pixel exposure values received into a single scalar value of the array of scalar values.

14. The system of claim 10, further comprising a decoder configured to:
identify at least one feature, of the image, in the quantized feature map;
deconvolve the at least one feature identified to produce a partially deconvolved feature map with dimensions equal to dimensions of the image; and
transmit the partially deconvolved feature map produced to a computer vision (CV) model.

15. The system of claim 10, further comprising a computer vision (CV) model.

16. The system of claim 15, wherein the at least one programmable kernel and the CV model are cooperatively trained by:
freezing a weight associated with the CV model; and
training a pipeline composed of the at least one programmable kernel and the CV model with the weight frozen, wherein the training the pipeline comprises adjusting a weight of the at least one programmable kernel and maintaining the weight frozen associated with the CV model.

17. The system of claim 10, wherein the encoder further comprises an analog processing element (PE) and an analog-to-digital converter (ADC).

18. The system of claim 17, wherein the analog PE comprises: (i) a p-channel metal oxide semiconductor (PMOS) source follower (PSF) buffer, (ii) a switched-capacitor multiplier (SCM), (iii) a flipped voltage follower (FVF), or (iv) any combination of (i)-(iii).

19. The system of claim 17, wherein the analog PE is configured to:
obtain a weight from the at least one programmable kernel;
using the weight obtained, perform the convolving of the analog image data received with the at least one programmable kernel utilizing a multiply-accumulate (MAC) operation; and
transmit a result of the MAC operation to the ADC, wherein the ADC is configured to perform the quantizing to generate the quantized feature map.

20. An apparatus for compressing image data, the apparatus comprising:
means for receiving analog image data comprising an array of pixel exposure values representing an image;
means for convolving the analog image data received with at least one programmable kernel to produce an array of scalar values; and
means for quantizing the array of scalar values to generate a quantized feature map, wherein the quantized feature map is a compressed representation of the image relative to the analog image data received.
